(19) United States
(12) Patent Application Publication
(10) Pub. No.: US 2026/0210247 A1
(43) Pub. Date: Jul. 23, 2026

(54) TRAVEL DEVICE, TUNNEL BORING MACHINE, TRAILING CAR, TRANSPORT VEHICLE, TUNNEL BORING SYSTEM, AND MOVEMENT METHOD

(71) Applicant: KOMATSU LTD., Tokyo (JP)

(72) Inventors: Kazunari Kawai, Tokyo (JP); Shinichi Terada, Tokyo (JP); Keigo Hiratsuka, Tokyo (JP)

(73) Assignee: KOMATSU LTD., Tokyo (JP)

(21) Appl. No.: 19/137,668

(22) PCT Filed: Feb. 14, 2024
(86) PCT No.: PCT/JP2024/005059

§ 371 Date: Jun. 11, 2025

(30) Foreign Application Priority Data
Feb. 17, 2023 (JP) 2023-023731
May 10, 2023 (JP) 2023-077783

(51) Int. Cl. E21D 9/10; E21D 9/11

(52) U.S. Cl. CPC E21D 9/1093; E21D 9/11

(57) ABSTRACT

This travel device is a travel device used in a tunnel boring machine, and including: wheels; and a variable mechanism configured to change an angle formed by a line orthogonal to a rotation axis of the wheels and a vertical line between a first state in which the travel device travels on a flat road surface and a second state in which the travel device travels on an arcuate road surface in frontal view.

### TECHNICAL FIELD

The present invention relates to a travel device, a tunnel boring machine, a trailing car, a transport vehicle, a tunnel boring system, and a movement method.

The present invention claims priority based on Japanese Patent Application No. 2023-023731 filed in Japan on Feb. 17, 2023 and Japanese Patent Application No. 2023-077783 filed in Japan on May 10, 2023, the contents of which are incorporated herein by reference.

### BACKGROUND ART

In general, a tunnel boring machine (TBM) needs not only to bore and move forward in a tunnel but also to move forward or rearward in the tunnel after boring. At that time, the tunnel boring machine travels forward or rearward using a crawler travel device.

Patent Document 1 discloses a tunnel boring machine for rock boring. The tunnel boring machine includes a tilt type crawler travel device. The crawler travel device does not have a variable configuration.

### CITATION LIST

### Patent Document

Patent Document 1: Chinese Utility Model Application Publication No. 217001866

### SUMMARY OF INVENTION

### Technical Problem

In Patent Document 1, since the crawler travel device is tilted but not variable, it is difficult to move depending on the road surface condition in a room. Since the room may have an arcuate road surface or have a flat road surface, the travel device of Patent Document 1 cannot cope with it.

Therefore, an object of the present invention is to provide a travel device, a tunnel boring machine, a trailing car, a transport vehicle, a tunnel boring system, and a movement method that can stably travel regardless of whether the room has an arcuate road surface or has a flat road surface.

### Solution to Problem

A travel device according to one aspect of the present invention is a travel device used in a tunnel boring machine, the travel device including: wheels; and a variable mechanism configured to change an angle formed by a line orthogonal to a rotation axis of the wheels and a vertical line between a first state in which the travel device travels on a flat road surface and a second state in which the travel device travels on an arcuate road surface in frontal view.

### Advantageous Effects of Invention

According to the above aspect, it is possible to stably travel regardless of whether the room has an arcuate road surface or has a flat road surface.

### BRIEF DESCRIPTION OF DRAWINGS

FIG. 1 is a side view of a tunnel boring system according to a first embodiment.

FIG. 2 is a perspective view illustrating a state in which a travel device supporting a boring machine according to the first embodiment travels on a flat road surface.

FIG. 3 is a perspective view illustrating a state in which the travel device supporting the boring machine according to the first embodiment travels on an arcuate road surface.

FIG. 4 is a side view of the boring machine according to the first embodiment.

FIG. 5 is a front view of the boring machine according to the first embodiment, and is an operation explanatory view of wheels of the travel device.

FIG. 6 is a perspective view illustrating the travel device supporting the boring machine according to the first embodiment together with an attachment mechanism to a front lower portion of a front body.

FIG. 7 is a side view of the travel device supporting the boring machine according to the first embodiment.

FIG. 8 is a front view of an example of the travel device supporting the boring machine according to the first embodiment.

FIG. 9 is a front view of another example of the travel device supporting the boring machine according to the first embodiment.

FIG. 10 is a top view of the travel device supporting the boring machine according to the first embodiment including an X-X cross section of FIG. 8.

FIG. 11 is a view illustrating an example of an excavation procedure by the boring machine according to the first embodiment.

FIG. 12 is a view illustrating an example of a retreat procedure by the boring machine according to the first embodiment.

FIG. 13 is a view illustrating an example of a forward movement procedure without boring by the boring machine according to the first embodiment.

FIG. 14 is an arrangement explanatory view of the travel device during curve boring by the boring machine according to the first embodiment.

FIG. 15 is a view as viewed from an arrow XV of FIG. 14, and is an arrangement explanatory view of the travel device at the time of traveling on an arcuate road surface.

FIG. 16 is a side view of a trailing car according to the first embodiment.

FIG. 17 is a perspective view of the travel device supporting the trailing car according to the first embodiment.

FIG. 18 is a front view illustrating a state in which the travel device supporting the trailing car according to the first embodiment travels on a flat road surface.

FIG. 19 is a front view illustrating a state in which the travel device supporting the trailing car according to the first embodiment travels on an arcuate road surface.

FIG. 20 is a view illustrating an example of an excavation procedure by a boring machine according to a comparative example.

FIG. 21 is a perspective view of a travel device according to a second embodiment.

FIG. 22 is a side view of a tunnel boring system according to a third embodiment.

FIG. 23 is a perspective view of a travel device according to the third embodiment.

FIG. 24 is a front view illustrating a state in which the travel device according to the third embodiment travels on a flat road surface.

FIG. 25 is a front view illustrating a state in which the travel device according to the third embodiment travels on an arcuate road surface.

FIG. 26 is a perspective view illustrating a transport vehicle group according to a fourth embodiment.

### DESCRIPTION OF EMBODIMENTS

Hereinafter, embodiments of the present invention will be described with reference to the drawings. In the embodiments, as an example of a tunnel boring system including a tunnel boring machine, an example including a tunnel boring machine that can move a predetermined distance in a front-rear direction by fixing a gripper to a tunnel wall of a tunnel will be described.

### First Embodiment

### Tunnel Boring System

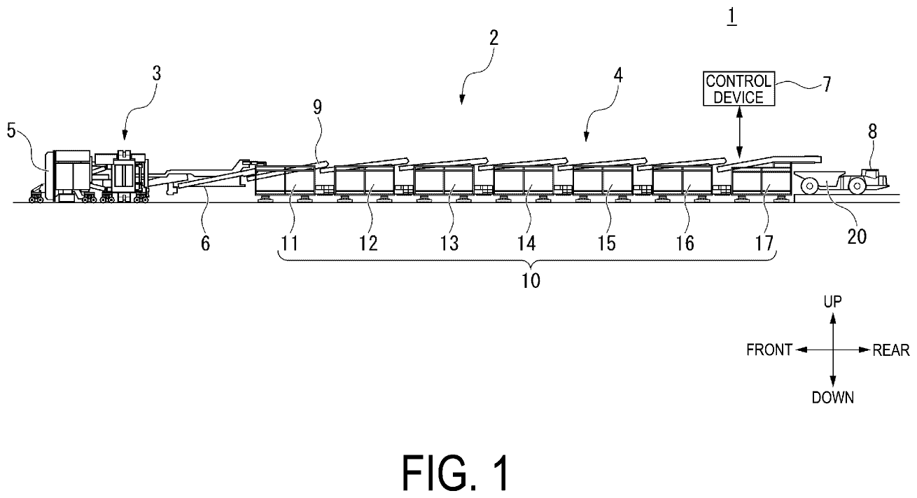

FIG. 1 is a side view of a tunnel boring system 1 according to the first embodiment.

As illustrated in FIG. 1, the tunnel boring system 1 includes a boring transport vehicle 2 that bores and transports borings. The boring transport vehicle 2 extends in a front-rear direction. The boring transport vehicle 2 includes a boring machine 3 and a trailing car group 4.

For example, the boring machine 3 is a tunnel boring machine for rock boring. The boring machine 3 is arranged on a face (boring) side in the boring transport vehicle 2. The boring machine 3 includes a cutter head 5 rotatable about a predetermined axis. The boring machine 3 bores rock or the like by rotation of the cutter head 5.

The boring machine 3 is self-propelled.

In the example of the figure, the front end portion of a traction beam 6 is connected to the boring machine 3. In the example of the figure, the rear end portion of the traction beam 6 is connected to the front end portion of the trailing car at the foremost trailing car. Note that the boring machine 3 and the trailing car need not be connected by the traction beam 6. For example, the installation mode of the traction beam 6 can be changed according to the design specifications.

Hereinafter, a direction in which the vehicle travels while the boring machine 3 bores is referred to as a “vehicle front”, and a direction opposite to the vehicle front is referred to as a vehicle rear. The right hand with respect to the direction in which the vehicle travels while the boring machine 3 bores is referred to as a right side, and the left hand with respect to the direction in which the vehicle travels while the boring machine 3 bores is referred to as a left side. The right-left direction of the vehicle is referred to as a “width direction”. The up-down direction of the vehicle is a direction orthogonal to the front-rear direction and the width direction of the vehicle. The vehicle lower side is a side with wheels in the up-down direction of the vehicle. The vehicle upper side is an opposite side to the side with wheels in the up-down direction of the vehicle. In the example of the figure, the vehicle is arranged on a horizontal plane. A vehicle up-down direction, a vehicle upper side, and a vehicle lower side match an up-down direction (vertical direction), a vertical upper side, and a vertical lower side, respectively, in a state in which the vehicle is arranged on a horizontal plane. In the following description, the end of an element on the left side may be given a reference sign L, and the end of an element on the right side may be given a reference sign R.

The trailing car group 4 is a vehicle group following the boring machine 3. The trailing car group 4 includes a transport vehicle group 10. Borings are transported rearward by an underground transport vehicle 20. Each vehicle of the transport vehicle group 10 is self-propelled. Note that each of the vehicles of the transport vehicle group 10 does not need to be self-propelled.

In the example of the figure, the vehicles of the transport vehicle group 10 are not connected by a traction member such as a coupling rod and a traction bracket. Note that each of the vehicles of the transport vehicle group 10 may be connected by the traction member. For example, the installation mode of the traction member can be changed according to the design specifications.

The transport vehicle group 10 is arranged between the boring machine 3 and the underground transport vehicle 20. For example, the transport vehicle group 10 may be mounted with an equipment storage, an operator seat, an oil tank, a hydraulic pump, a dust collector, a dust collector water treatment tank, a control panel, an inverter panel, a transformer, a cable yard, and the like.

In the example of the figure, the transport vehicle group 10 includes a total of seven vehicles from a first vehicle 11 to a seventh vehicle 17. The first vehicle 11 is the foremost trailing car of the transport vehicle group 10. In the example of the figure, the rear end portion of the traction beam 6 is connected to the front end portion of the first vehicle 11.

The borings bored by the rotation of the cutter head 5 are taken into a hopper (not illustrated) on the back surface side of the cutter head 5. The borings introduced into the hopper are transported rearward by a conveyor belt 9. The conveyor belt 9 is supported on an upper portion of the transport vehicle group 10 or the like. The conveyor belt 9 extends from the hopper to an upper position of the first vehicle 11, and then extends to a rear of an upper position of the seventh vehicle 17 through the upper side of the transport vehicle group 10. In the example of the figure, the conveyor belt 9 is divided between each of the cars, and a conveyor belt having a tilt rising rearward is mounted on each of the cars, and borings are sequentially transported.

The underground transport vehicle 20 is arranged on a rear side of the boring transport vehicle 2. The underground transport vehicle 20 is arranged on a tunnel entrance (ground) side in the boring transport vehicle 2. The underground transport vehicle 20 is self-propelled. The underground transport vehicle 20 may include a battery that can supply electric power to each of the vehicles of the transport vehicle group 10. The underground transport vehicle 20 may include a cab 8 that has an operator seat or the like.

For example, earth and sand bored by the boring machine 3 are sequentially conveyed to trailing cars by the conveyor belt 9, and finally loaded into the underground transport vehicle 20. For example, when fully loaded with earth and sand, the underground transport vehicle 20 starts movement and transport to the tunnel rear side and removes the earth and sand to a predetermined earth removal site.

Note that the underground transport vehicle 20 may function as a traction vehicle that can pull the transport vehicle group 10.

For example, the underground transport vehicle 20 may be swingably coupled to the seventh vehicle 17. For example, a coupling mode between the transport vehicle group 10 and the underground transport vehicle 20 can be changed according to the design specifications.

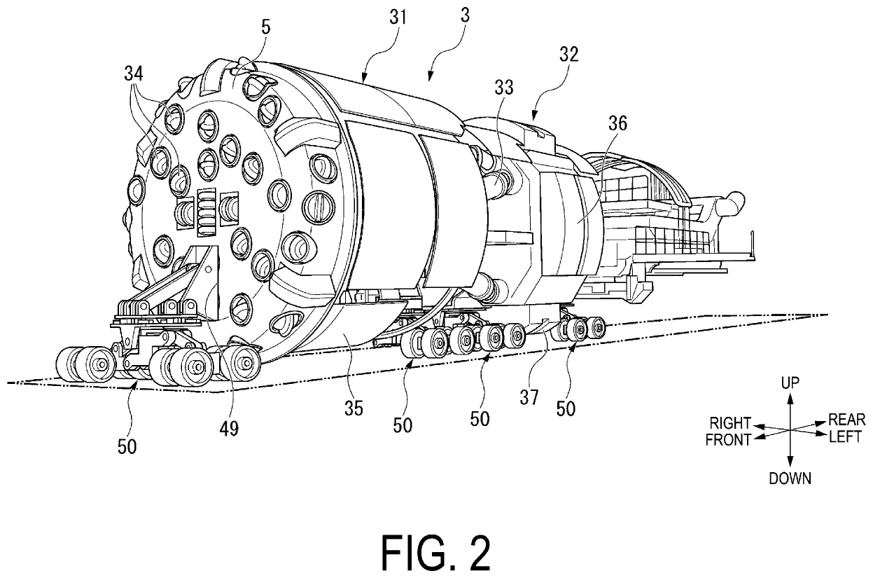

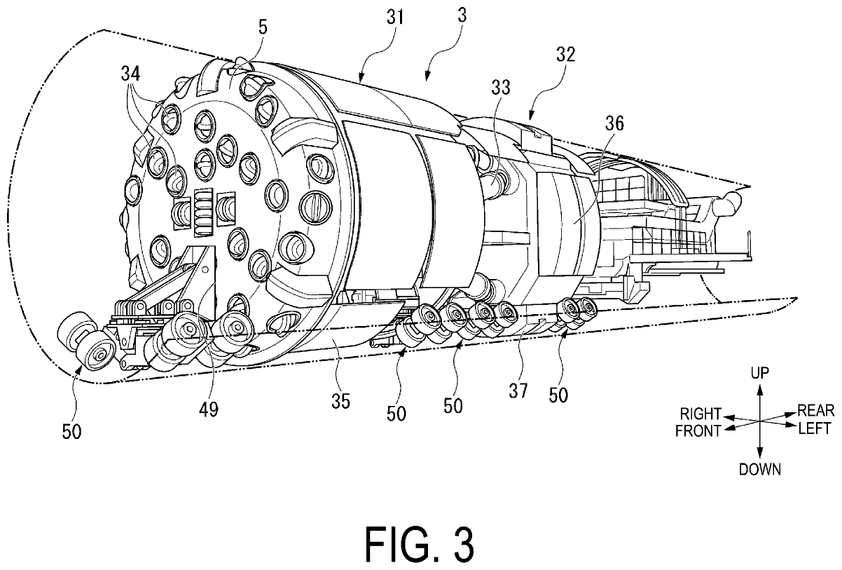

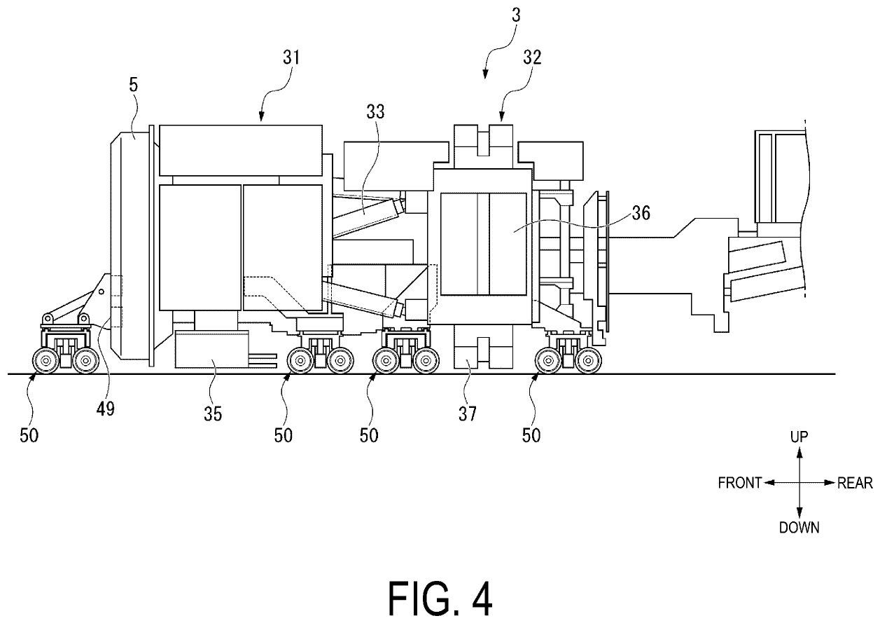

FIG. 2 is a perspective view illustrating a state in which a travel device 50 supporting the boring machine 3 according to the first embodiment travels on a flat road surface. FIG. 3 is a perspective view illustrating a state in which the travel device 50 supporting the boring machine 3 according to the first embodiment travels on an arcuate road surface. FIGS. 2 and 3 correspond to a case where the boring machine 3 moves without boring. In FIG. 2, the flat road surface is indicated by a two-dot chain line. In FIG. 3, the arcuate road surface is indicated by a two-dot chain line. FIG. 4 is a side view of the boring machine 3 according to the first embodiment.

With reference to FIGS. 2 to 4, the boring machine 3 includes a front body 31 to which the cutter head 5 for boring borings is attached, and a rear body 32 connected to the front body 31 via an extension-retraction mechanism 33.

The cutter head 5 includes a plurality of disc cutters 34. The disc cutters 34 are provided at the tip end portion of the cutter head 5. The boring machine 3 rotates the entire cutter head 5 while pressing the disc cutters 34 against the wall surface to be bored. By this, the borings are bored, and the boring machine 3 excavates.

The boring machine 3 includes a vertical support 35 (an example of a front body self-weight support mechanism) provided at the front body 31 and grippers 36 and 37 (an example of a rear body gripper) provided at the rear body 32. The vertical support 35 and the grippers 36 and 37 are examples of members supporting or fixing a part of the boring machine 3.

The vertical support 35 is provided at a lower portion of the front body 31. The vertical support 35 is movable in the up-down direction. For example, when the vertical support 35 moves downward, the vertical support 35 is brought into a grounded state. In the state in which the vertical support 35 is grounded, the front body 31 is brought into a state of being supported by the vertical support 35.

The grippers 36 and 37 are provided at right and left side portions and a lower portion of the rear body 32. The gripper 36 on the right and left side portions of the rear body 32 are movable in the right-left direction (width direction). For example, when the gripper 36 moves outward in the width direction, the gripper 36 is brought into a state of being in contact with the tunnel wall. In the state in which the gripper 36 is in contact with the tunnel wall, the rear body 32 is brought into a state of being supported by the gripper 36. Note that in a state in which the gripper 36 is pressed against the tunnel wall, the rear body 32 is brought into a state of being fixed by the gripper 36.

The gripper 37 (hereinafter, also called a “lower gripper 37”) at a lower portion of the rear body 32 is movable in the up-down direction. For example, when the lower gripper 37 moves downward, the lower gripper 37 is brought into a grounded state. In the state in which the lower gripper 37 is grounded, the rear body 32 is brought into a state of being supported by the lower gripper 37.

The extension-retraction mechanism 33 is provided between the front body 31 and the rear body 32. The extension-retraction mechanism 33 can extend and retract in the front-rear direction. In the example of the figure, the extension-retraction mechanism 33 is a lattice cylinder. Note that the extension-retraction mechanism 33 is not limited to the above, and may be another cylinder. For example, the configuration mode of the extension-retraction mechanism 33 can be changed according to the design specifications.

### Travel Device Used for Boring Machine

The tunnel boring system 1 includes the travel device 50 used for the boring machine 3. When the boring machine 3 moves without boring, the travel device 50 supports the entire boring machine 3 (see FIGS. 2 and 3, for example).

The travel device 50 is provided at each of the front body 31 and the rear body 32. In the example of the figure, the travel devices 50 are provided at a total of four locations of a front lower portion (specifically, the lower portion of the cutter head 5) and a rear lower portion of the front body 31, and a front lower portion and a rear lower portion of the rear body 32. For example, the travel device 50 is removable with respect to the front lower portion of the front body 31, and may be removable or may be irremovable with respect to other three locations (the rear lower portion of the front body 31 and the front lower portion and the rear lower portion of the rear body 32). The cutter head 5 includes an attachment portion 49 for the travel device 50.

Note that the number of installation locations of the travel device 50 supporting the boring machine 3 is not limited to the above, and may be three locations or less or five locations or more. For example, the installation location of the travel device 50 supporting the boring machine 3 can be changed according to the design specifications.

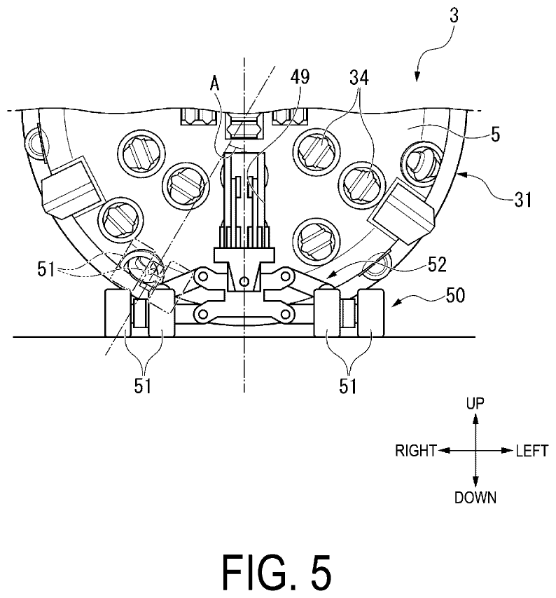

FIG. 5 is a front view of the boring machine 3 according to the first embodiment, and is an operation explanatory view of wheels 51 of the travel device 50. In FIG. 5, the flat road surface is indicated by a solid line, and the arcuate road surface is not illustrated.

With reference to FIG. 5, the travel device 50 includes the wheels 51 and a variable mechanism 52. In the example of the figure, one travel device 50 is provided with a total of eight wheels 51, with four on each of the right and left (the example of FIG. 5 illustrates two on each of the right and left on the front side). Note that the number of the wheels 51 to be installed is not limited to the above, and may be seven or less or nine or more. For example, the number of the wheels 51 of the travel device 50 to be installed can be changed according to the design specifications.

The variable mechanism 52 can change an angle A formed by a line orthogonal to a rotation axis of the wheels 51 and a vertical line between a first state in which the travel device 50 travels on a flat road surface and a second state in which the travel device 50 travels on an arcuate road surface in frontal view (in front view of FIG. 5). The frontal view corresponds to a case of being viewed from the vehicle front. The first state corresponds to the state illustrated in FIG. 2. The second state corresponds to the state illustrated in FIG. 3. In the first state, the angle A is zero. In the second state, the angle A is greater than zero. In the example of FIG. 5, the wheels 51 in a case where the angle A is zero are indicated by solid lines, and the wheels 51 (the wheel 51 on the right side in the example of FIG. 5) in the case where the angle A is greater than zero is indicated by a two-dot chain line.

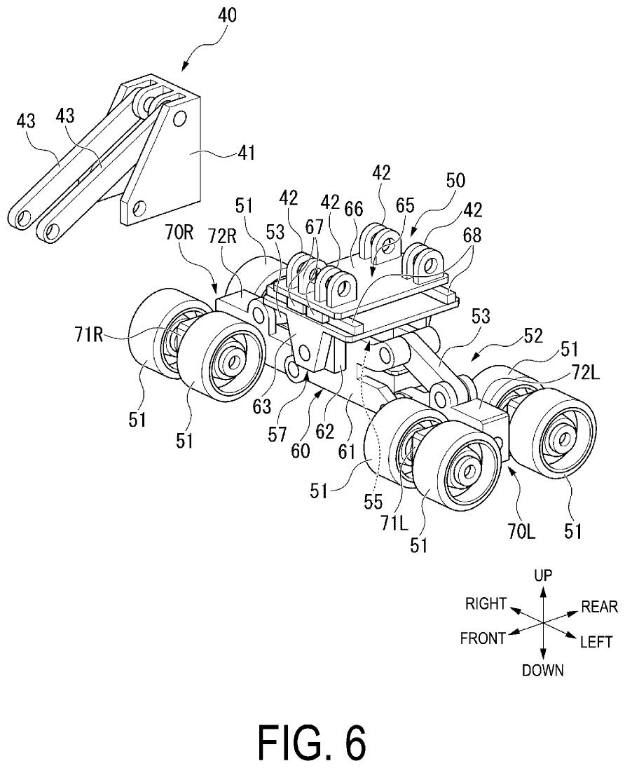

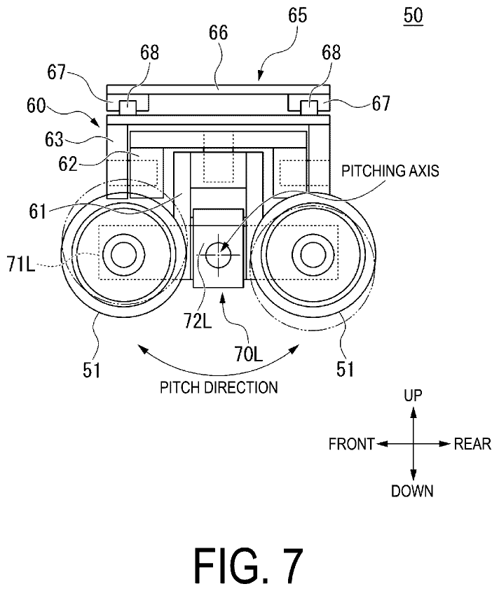

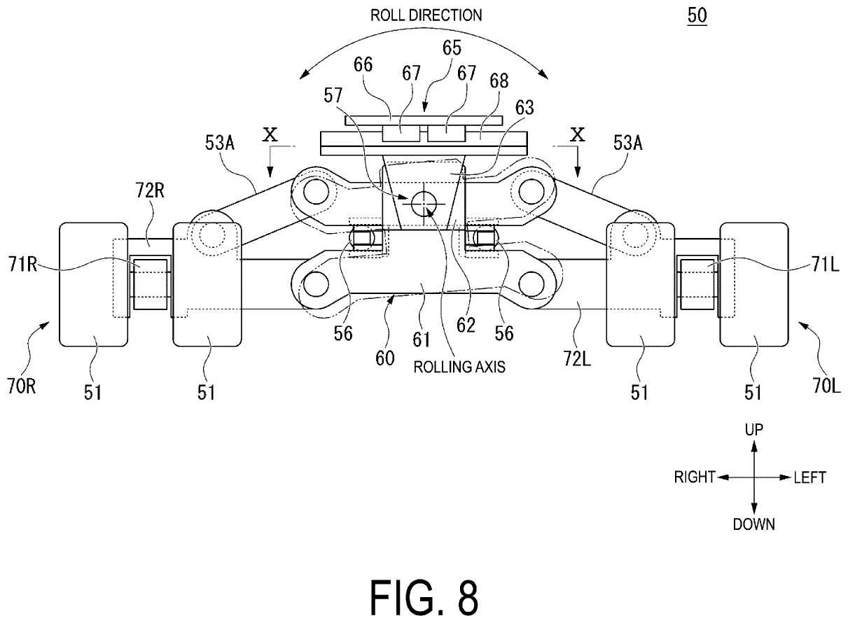

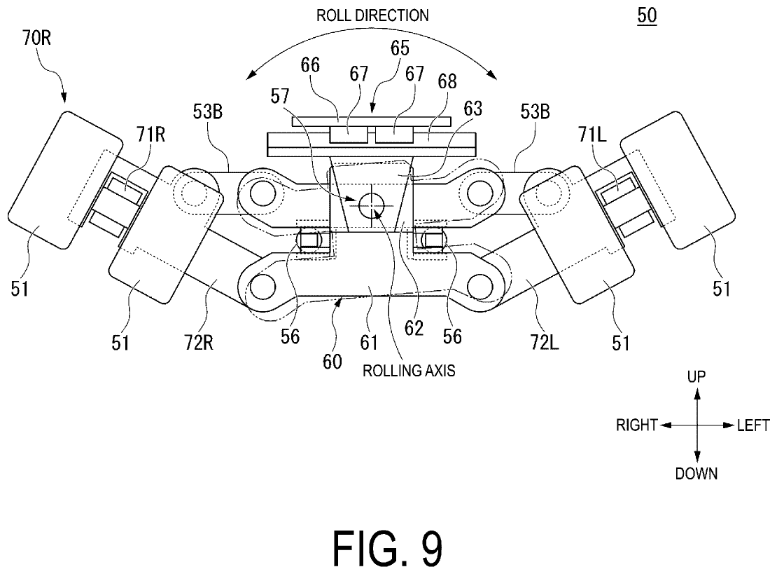

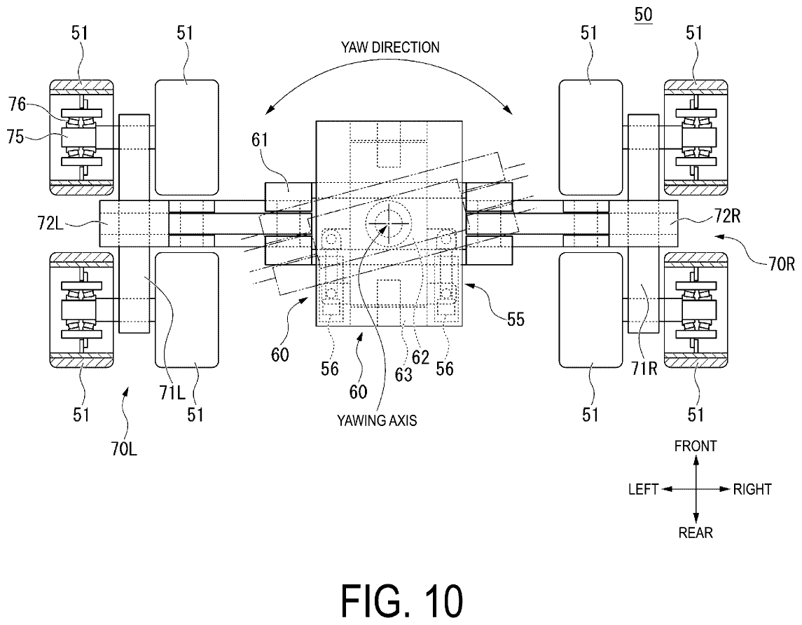

FIG. 6 is a perspective view illustrating the travel device 50 supporting the boring machine 3 according to the first embodiment together with an attachment mechanism 40 to the front lower portion of the front body 31. FIG. 7 is a side view of the travel device 50 supporting the boring machine 3 according to the first embodiment. FIG. 8 is a front view of an example of the travel device 50 supporting the boring machine 3 according to the first embodiment. FIG. 9 is a front view of another example of the travel device 50 supporting the boring machine 3 according to the first embodiment. FIG. 10 is a top view of the travel device 50 supporting the boring machine 3 according to the first embodiment including an X-X cross section of FIG. 8.

With reference to FIGS. 6 to 10, the travel device 50 is attached to the front lower portion of the front body 31 via the attachment mechanism 40. Note that the travel device 50 may be attached to another portion of the boring machine 3 not via the attachment mechanism 40 (but via another attachment mechanism).

The attachment mechanism 40 includes an attachment block 41, an attachment bracket 42, and an attachment arm 43.

The attachment block 41 has a trapezoidal shape in side view. Note that the shape of the attachment block 41 is not limited to the above, and can be changed according to the design specifications. For example, the rear portion of the attachment block 41 may be detachably attached to a front lower portion (the attachment portion 49) of the cutter head 5 of the front body 31. For example, the lower portion of the attachment block 41 may be detachably attached to the upper portion of the travel device 50.

For example, the lower portion of the attachment bracket 42 may be detachably attached to the upper portion of the travel device 50. A plurality of the attachment brackets 42 are provided. In the example of the figure, a total of four pairs of the attachment brackets 42 are provided at the travel device 50, with one pair each on the right and left at the front portion and one pair each on the right and left at the rear portion of the upper portion (two each on the right and left). Two sets of the four sets of attachment brackets 42 are provided at each of the front lower portions of the right and left side walls of the attachment block 41 and the front lower portions of a pair of right and left attachment arms 43. Note that the number of the attachment brackets 42 to be installed is not limited to the above, and can be changed according to the design specifications.

In the example of the figure, one end portion (rear upper portion) of the attachment arm 43 overlaps the upper portion of the attachment block 41 in side view. The one end portion of the attachment arm 43 is coupled to the upper portion of the attachment block 41. The one end portion of the attachment arm 43 may be swingable about an axis along the right-left direction at a coupling portion with the attachment block 41.

In the example of the figure, the other end portion (front lower portion) of the attachment arm 43 overlaps the attachment bracket 42 on the front side in side view. The other end portion of the attachment arm 43 is coupled to the attachment bracket 42 on the front side. The other end portion of the attachment arm 43 may be swingable about an axis along the right-left direction at a coupling portion with the attachment bracket 42 on the front side.

The variable mechanism 52 includes a rod 53 at a part of a mechanism for changing the angle A. A pair of right and left rods 53 are provided. The rods 53 are detachably attached to a part of the variable mechanism 52. For example, in order to change the angle A, it is preferable to prepare in advance a plurality of rods 53 having different lengths from each other.

The variable mechanism 52 changes the angle A by switching between rods 53A and 53B having different lengths from each other as the rods 53. For example, by preparing two types of rods 53A and 53B having different lengths from each other, the variable mechanism 52 can change the angle A between the first state and the second state in frontal view. In the example of FIG. 8, the wheels 51 in a case where the angle A is zero are indicated, and a case of including the first rod 53A having a predetermined length is indicated. The example of FIG. 9 illustrates the wheels 51 in a case where the angle A is greater than zero, and illustrates a case of including the second rod 53B shorter than the length of the first rod 53A.

Specifically describing the variable mechanism 52, the angle A is changed by changing the length of the rod 53 (corresponding to a part of the first link mechanism) while making the rod 53 swingable without changing the length of side frames 72L and 72R (corresponding to a part of the second link mechanism) while making the side frames 72L and 72R swingable. More specifically, the variable mechanism 52 is achieved by connecting one end portion of the rod 53 (corresponding to one end portion of the first link mechanism) to the side frames 72L and 72R. In this manner, the variable mechanism 52 can change the angle A by switching between the rods 53A and 53B having different lengths from each other as the rods 53.

Note that the type of rod is not limited to the above, and can be changed according to the design specifications. For example, by changing the length of the rod, it is possible to cope with tunnels having various diameters (including a flat surface).

The travel device 50 includes a yawing mechanism 55 that can swing the wheels 51 in a yaw direction on an up-down axis of the travel device 50. The yawing mechanism 55 is provided at a part of a center frame structure 60. The yawing mechanism 55 includes a pair of right and left yawing cylinders 56. The yawing cylinders 56 can extend and retract in the front-rear direction.

The travel device 50 includes a rolling mechanism 57 that can swing the wheels 51 in a roll direction on a front-rear axis of the travel device 50. The rolling mechanism 57 is provided at a part of the center frame structure 60.

The center frame structure 60 includes a lower frame 61, a middle frame 62, and an upper frame 63.

A center upper portion in the right-left direction of the lower frame 61 overlaps the middle frame 62 in top view. The center upper portion in the right-left direction of the lower frame 61 is coupled to the middle frame 62. The lower frame 61 is swingable about an axis (yawing axis) along the up-down direction (swingable in the yaw direction) at a coupling portion with the middle frame 62 (see FIG. 10).

A pair of front and rear wall portions of the middle frame 62 overlap the lower portion of the upper frame 63 in front view. The pair of front and rear wall portions of the middle frame 62 are coupled to a pair of front and rear wall portions, respectively, of the lower portion of the upper frame 63. The middle frame 62 is swingable about an axis (rolling axis) along the front-rear direction (swingable in the roll direction) at a coupling portion with the upper frame 63 (see FIG. 8). Note that the lower frame 61 also swings in the roll direction together with the middle frame 62.

The travel device 50 includes a slider mechanism 65 that can move the wheels 51 in the right-left direction of the travel device 50. The slider mechanism 65 is provided at the upper portion of the upper frame 63. The slider mechanism 65 includes a slider plate 66 having a rectangular shape in top view, a slider guide 67 provided at a lower surface of the slider plate 66, and a slider rail 68 provided at an upper portion of the upper frame 63.

The slider guide 67 overlaps a part of the slider rail 68 in front view and top view. The slider guide 67 has an inverted recess shape along an upper outer shape of the slider rail 68 having a rectangular shape in side view. A plurality of the slider guides 67 are provided. In the example of the figure, a total of four slider guides 67 are provided at the slider plate 66, with two at each on the right and left on a front lower surface and a rear lower surface. Note that the number of the slider guides 67 to be installed is not limited to the above, and can be changed according to the design specifications.

A plurality of the slider rails 68 are provided. In the example of the figure, a total of two slider rails 68 are provided at the upper frame 63, with one on each of a front upper surface and a rear upper surface. Note that the number of the slider rails 68 to be installed is not limited to the above, and can be changed according to the design specifications.

The travel device 50 includes pitching mechanisms 70L and 70R that can swing the wheels 51 in a pitch direction on a right-left axis of the travel device 50. A pair of the right and left pitching mechanisms 70L and 70R are provided. The pitching mechanisms 70L and 70R include pitching frames 71L and 71R and the side frames 72L and 72R.

The pitching frames 71L and 71R extend along the front-rear direction. The pitching frames 71L and 71R rotatably support the wheels 51. In the example of the figure, a pair of the right and left wheels 51 are coupled to each of the front end portion and the rear end portion of the pitching frames 71L and 71R via an axle 75. Each of the wheels 51 is rotatable about an axis along the right-left direction at a coupling portion with the pitching frames 71L and 71R. For example, the axle 75 may be coupled to the wheels 51 via a bearing 76.

Center portions in the front-rear direction of the pitching frames 71L and 71R overlap outside portions in the right-left direction of the side frames 72L and 72R in side view. The center portions in the front-rear direction of the pitching frames 71L and 71R are coupled to the outside portions in the right-left direction of the side frames 72L and 72R. The pitching frames 71L and 71R are swingable about an axis (pitching axis) along the right-left direction (swingable in the pitch direction) at coupling portions with the side frames 72L and 72R (see FIG. 7).

Inner end portions in the right-left direction of the side frames 72L and 72R overlap outer end portions in the right-left direction of the lower portion of the lower frame 61 in front view. Outer end portion in the right-left direction of the lower portion of the lower frame 61 may be bent downward from an outside part of a part extending in the right-left direction of the lower portion of the lower frame 61 in front view. The inner end portions in the right-left direction of the side frames 72L and 72R are coupled to the outer end portions in the right-left direction of the lower frame 61. The side frames 72L and 72R are swingable about an axis along the front-rear direction at a coupling portion with the lower frame 61. The side frames 72L and 72R constitute a part of the variable mechanism 52.

Parts projecting upward from the front and rear of outside portions in the right-left direction of the side frames 72L and 72R (hereinafter also called a “pair of front and rear protrusion portions”) overlap one end portion (outer end portions in the right-left direction) of the rod 53 in front view. The pair of front and rear protrusion portions of the side frames 72L and 72R are coupled to one end portion of the rod 53. The side frames 72L and 72R may be swingable about an axis along the front-rear direction at a coupling portion with the one end portion of the rod 53.

The outer end portion in the right-left direction of the upper portion of the lower frame 61 overlaps the other end portion (inner end portion in the right-left direction) of the rod 53 in front view. The outer end portion in the right-left direction of the upper portion of the lower frame 61 may be bent upward from an outside part of a part extending in the right-left direction of the upper portion of the lower frame 61 in front view. The outer end portion in the right-left direction of the upper portion of the lower frame 61 is coupled to the other end portion of the rod 53. The lower frame 61 may be swingable about an axis along the front-rear direction at a coupling portion with the other end portion of the rod 53. The lower frame 61 constitutes a part of the variable mechanism 52.

The travel device 50 includes a mechanism (an example of the first link mechanism) including the rod 53 as the mechanism for changing the angle A, and a mechanism (an example of the second link mechanism) including the lower frame 61 and the side frames 72L and 72R to which the one end portion of the rod 53 is connected. By fixing the lengths of the lower frame 61 and the side frames 72L and 72R (an example of the length of the second link mechanism) and switching between the rods 53A and 53B having different lengths from each other as the rods 53, the variable mechanism 52 changes the length of the rod 53 (an example of the length of the first link mechanism) connected to the outer end portion in the right-left direction of the upper portion of the lower frame 61 and the pair of front and rear protrusion portions of the side frames 72L and 72R.

### Movement Method

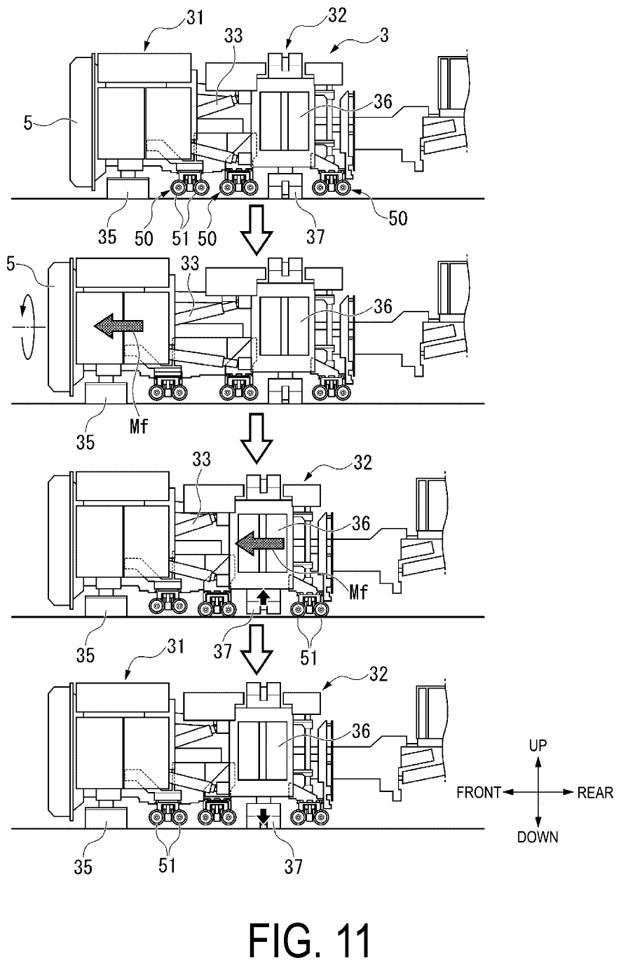

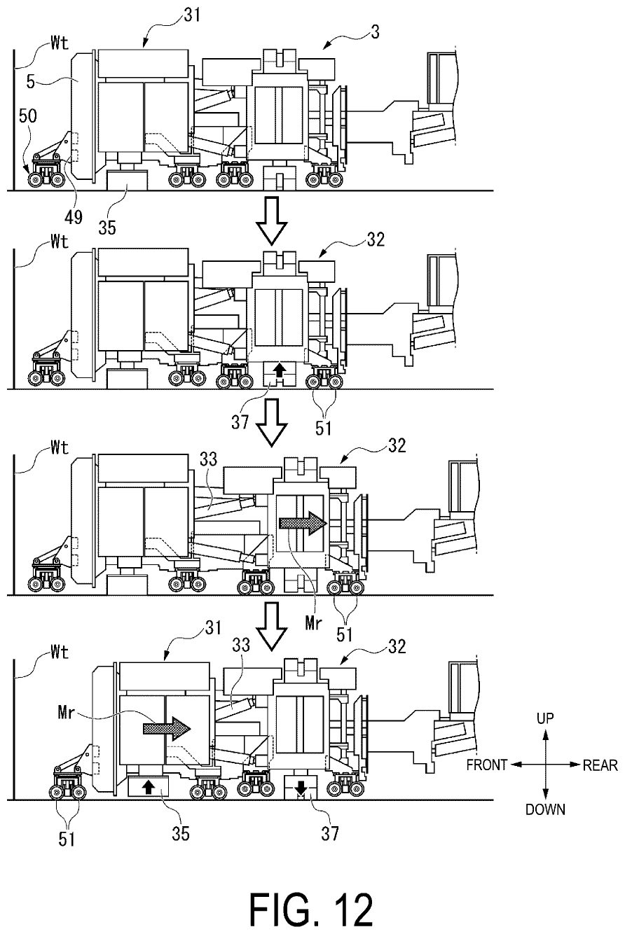

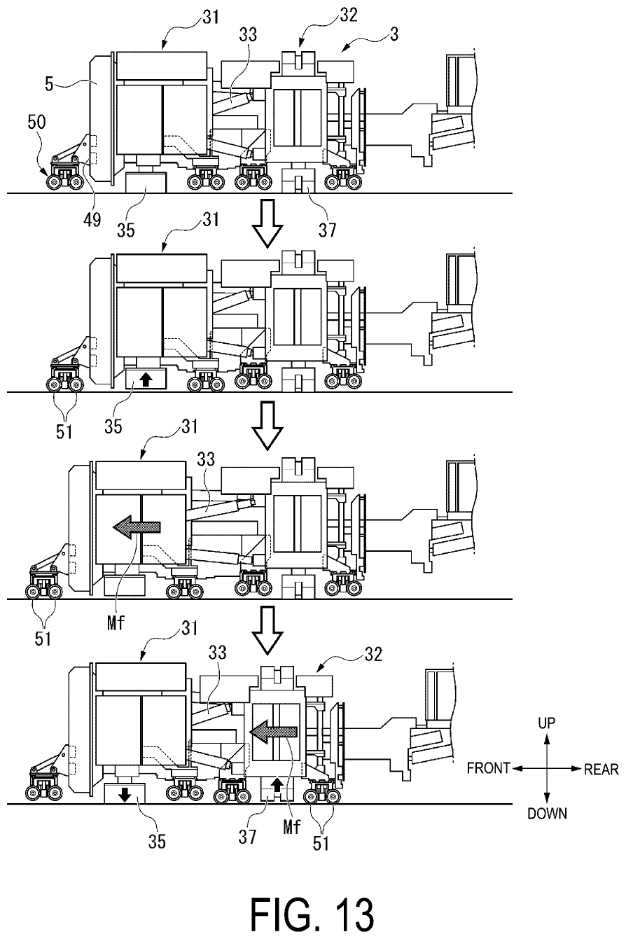

FIG. 11 is a view illustrating an example of an excavation procedure by the boring machine 3 according to the first embodiment. FIG. 12 is a view illustrating an example of a retreat procedure by the boring machine 3 according to the first embodiment. FIG. 13 is a view illustrating an example of a forward movement procedure without boring by the boring machine 3 according to the first embodiment.

With reference to FIGS. 11 to 13, a movement method of the present embodiment is a movement method for moving the boring machine 3 including the front body 31 to which the cutter head 5 for boring borings is attached, and the rear body 32 connected to the front body 31 via the extension-retraction mechanism 33, in which after the travel device 50 is provided at each of the front body 31 and the rear body 32, one of the front body 31 and the rear body 32 is moved by extending and retracting the extension-retraction mechanism 33 in a state in which the other of the front body 31 and the rear body 32 is fixed.

Note that the lower surface of the vertical support 35 and the lower surface of the lower gripper 37 have an arcuate shape when viewed from the front. Therefore, in a case of a flat road surface, an attachment (not illustrated) or the like that can flatten the lower surface of the vertical support 35 and the lower surface of the lower gripper 37 may be mounted. This can obtain a reaction force while preventing tipping.

### Example of Excavation Procedure of Boring Machine

The excavation procedure (an example of the movement method) of the boring machine 3 includes a rear body fixing step of fixing the rear body 32 to a tunnel by the grippers 36 and 37, a front body self-weight supporting step of grounding the vertical support 35 and supporting the self-weight of the front body 31 after the rear body fixing step, a forward-moving boring step of moving the front body 31 forward and performing boring by the cutter head 5 after the front body self-weight supporting step, a rear-body travel device grounding step of releasing the grippers 36 and 37 and grounding the travel device 50 provided at the rear body 32 after the forward-moving boring step, and a rear body forward-moving step of retracting the extension-retraction mechanism 33 to move the rear body 32 forward together with the travel device 50 after the rear-body travel device grounding step.

For example, the excavation procedure by the boring machine 3 is performed by the following procedure as illustrated in FIG. 11.

First, as illustrated in the uppermost view of FIG. 11, the extension-retraction mechanism 33 is retracted to a predetermined distance for the purpose of excavation (e.g., a lattice cylinder retracted state). Next, the gripper 36 of the rear body 32 is overhung and the lower gripper 37 of the rear body 32 is grounded to fix the rear body 32 (corresponding to the rear body fixing step). Note that the lower gripper 37 may be grounded first in order to adjust the position where the gripper 36 is overhung.

Next, the vertical support 35 is grounded to support the self-weight of the front body 31 (corresponding to the front body self-weight supporting step). Note that the vertical support 35 supports the self-weight of the front body 31 and slides on the tunnel wall during boring. The vertical support 35 is brought into a state of not moving when the relationship between the self-weight of the front body 31 and the frictional force against the tunnel wall satisfies a predetermined condition. For example, the vertical support 35 may be in a state of being constantly grounded and sliding on the road surface of the room at the time of excavation. This can perform forward boring while the vertical support 35 supports the self-weight of the front body 31.

The wheels 51 are basically not grounded. Note that since the vertical support 35 can slide on the road surface of the room, the wheels 51 may be grounded. On the other hand, when the rear body 32 is pulled, the wheels 51 are not grounded because it is desired not to move the front body 31 by the frictional force with the road surface of the vertical support 35.

Next, as illustrated in the second view from the top of FIG. 11, while rotating the cutter head 5, a reaction force is obtained from the gripper 36 that is overhung, and the extension-retraction mechanism 33 is extended to a predetermined distance. By this, the boring machine 3 excavates in an arrow Mf direction (corresponding to the forward-moving boring step).

Next, as illustrated in the third view from the top of FIG. 11, the gripper 36 that is overhung of the rear body 32 is loosened, and the lower gripper 37 is moved upward. Then, the rear body 32 is brought into a state of being supported by the wheels 51 (corresponding to the rear-body travel device grounding step). Next, the extension-retraction mechanism 33 is retracted to a predetermined distance in this state, and the rear body 32 is moved forward in the arrow Mf direction while being rolled by the wheels 51 (corresponding to the rear body forward-moving step).

Next, as illustrated in the lowermost view of FIG. 11, the gripper 36 of the rear body 32 is overhung and the lower gripper 37 of the rear body 32 is grounded to fix the rear body 32 for re-excavation.

### Example of Retreat Procedure of Boring Machine

In the retreat procedure (an example of the movement method) of the boring machine 3, after the boring of the tunnel by the cutter head 5 is completed, the boring machine 3 is moved rearward by an allowable distance for the travel device 50 at least between the tunnel wall in front of the cutter head 5 and the cutter head 5, and after the travel device 50 is attached to the cutter head 5, the boring machine 3 is retreated.

For example, the retreat procedure of the boring machine 3 is performed by the following procedure as illustrated in FIG. 12.

First, as illustrated in the uppermost view of FIG. 12, the vertical support 35 of the front body 31 is already grounded after completion of the excavation (e.g., the lattice cylinder retracted state). Next, the travel device 50 is installed at the front lower portion of the cutter head 5. Note that when the boring is completed, there may be a tunnel wall Wt (tunnel end portion) in front of the front body 31. Therefore, when the tunnel wall Wt is present in front of the front body 31, it is necessary to slightly move the boring machine 3 rearward to make a space between the tunnel wall Wt and the cutter head 5, and then install the travel device 50. The travel device 50 may be constantly installed in or removed from a portion other than the front lower portion (the attachment portion 49) of the cutter head 5 (other portion of the boring machine 3). Note that the lattice cylinder at the time of completion of normal boring is in an extended state, but the lattice cylinder retracted state is basically displayed at the time of machine stopping.

Next, as illustrated in the second view from the top of FIG. 12, the lower gripper 37 of the rear body 32 is moved upward. Then, the rear body 32 is brought into a state of being supported by the wheels 51.

Next, as illustrated in the third view from the top of FIG. 12, the extension-retraction mechanism 33 is extended to a predetermined distance. By this, the rear body 32 is retreated in an arrow Mr direction while being rolled by the wheels 51.

Next, as illustrated in the lowermost view of FIG. 12, the lower gripper 37 of the rear body 32 is grounded. Next, the vertical support 35 of the front body 31 is moved upward. Then, the front body 31 is brought into a state of being supported by the wheels 51. Next, the extension-retraction mechanism 33 is retreated to a predetermined distance in this state, and the front body 31 is retracted in the arrow Mr direction while being rolled by the wheels 51.

Example of Forward Movement Procedure without Boring by Boring Machine

In the forward movement procedure (an example of the movement method) without boring by the boring machine 3, the boring machine 3 is moved forward after the cutter head 5 is attached with the travel device 50.

For example, the forward movement procedure without boring by the boring machine 3 is performed by the following procedure as illustrated in FIG. 13.

First, as illustrated in the uppermost view of FIG. 13, the lower gripper 37 of the rear body 32 and the vertical support 35 of the front body 31 are grounded in a state in which the extension-retraction mechanism 33 is retracted to a predetermined distance (e.g., the lattice cylinder retracted state). Next, the travel device 50 is installed at the front lower portion (the attachment portion 49) of the cutter head 5. The travel device 50 may be constantly installed in or removed from a portion other than the front lower portion of the cutter head 5 (other portion of the boring machine 3).

Next, as illustrated in the second view from the top of FIG. 13, the vertical support 35 of the front body 31 is moved upward. Then, the front body 31 is brought into a state of being supported by the wheels 51.

Next, as illustrated in the third view from the top of FIG. 13, the extension-retraction mechanism 33 is extended to a predetermined distance. By this, the front body 31 is moved forward in the arrow Mf direction while being rolled by the wheels 51.

Next, as illustrated in the lowermost view of FIG. 13, the vertical support 35 of the front body 31 is grounded, and the lower gripper 37 of the rear body 32 is moved upward. Then, the rear body 32 is brought into a state of being supported by the wheels 51. Next, the extension-retraction mechanism 33 is retracted to a predetermined distance in this state, and the rear body 32 is moved forward in the arrow Mf direction while being rolled by the wheels 51.

### Example of Arrangement of Travel Device

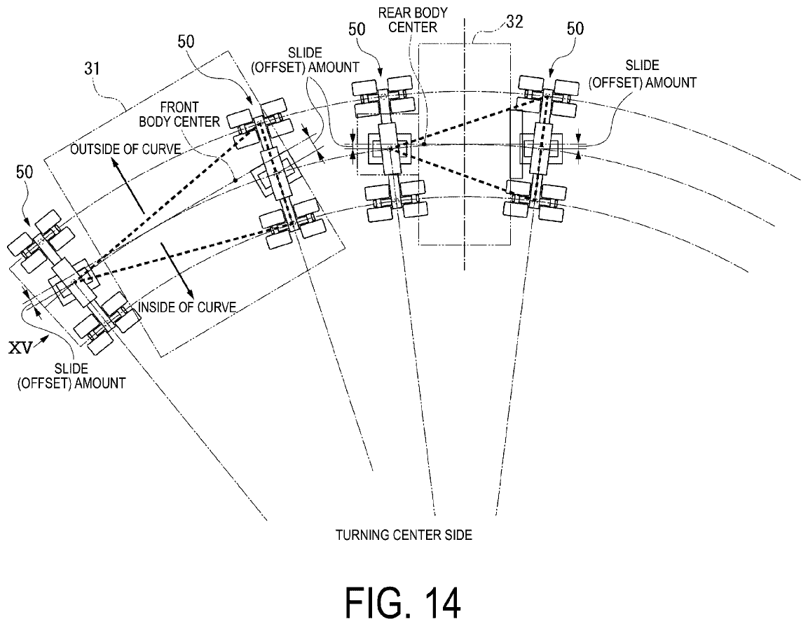

FIG. 14 is an arrangement explanatory view of the travel device 50 during curve boring by the boring machine 3 according to the first embodiment.

With reference to FIG. 14, for example, in order to suppress side slip of the travel device 50 during turning, it is preferable that the steering geometry is based on the Ackermann-Jeantaud scheme.

For example, the thrust of the yawing cylinder 56 of the travel device 50 is preferably the thrust necessary for steering during traveling. For example, right-left offset while the boring machine 3 is traveling on a curve having an arcuate shape may be free. For example, when steering is necessary while the boring machine 3 is stopped, the main body may be lifted up by the vertical support 35 of the front body 31 and the grippers 36 and 37 of the rear body 32, and then steered.

As described above, the travel device 50 includes the slider mechanism 65 that can move the wheels 51 in the right-left direction of the travel device 50 at the upper portion of the upper frame 63. The slider mechanism 65 functions as a mechanism that offsets the travel device 50 to the turning center side in order to cause the travel device 50 to follow a curve at a curve portion during curve boring. Note that in top view of FIG. 14, the rolling mechanism 57 of the travel device 50 of each of the front body 31 and the rear body 32 may be locked at a neutral position in order to keep the centers of gravity of the front body 31 and the rear body 32 within a triangle indicated by a broken line. For example, the lock may be fixed with a block, a pin, or the like.

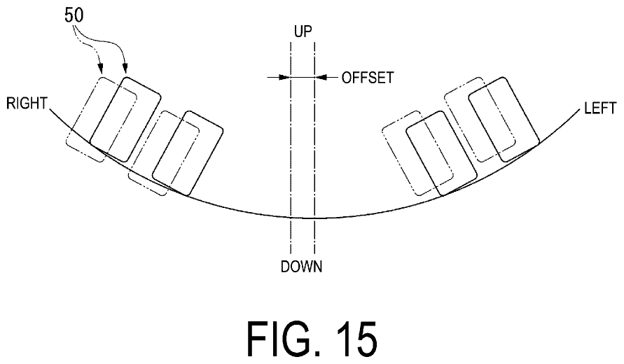

FIG. 15 is a view as viewed from the arrow XV of FIG. 14, and is an arrangement explanatory view of the travel device 50 at the time of traveling on an arcuate road surface.

With reference to FIG. 15, in order to cause the front and rear wheels to follow a curve at the time of traveling on an arcuate road surface, it is necessary to slide (offset) the travel device 50 inward of the curve with respect to the front body center and the rear body center. Since the slide of the travel device 50 may follow the arc, an actuator such as a hydraulic cylinder is unnecessary. Note that since the offset itself basically does not occur at the time of traveling on a flat road surface, the slide may be fixed.

### Travel Device Used for Trailing Car

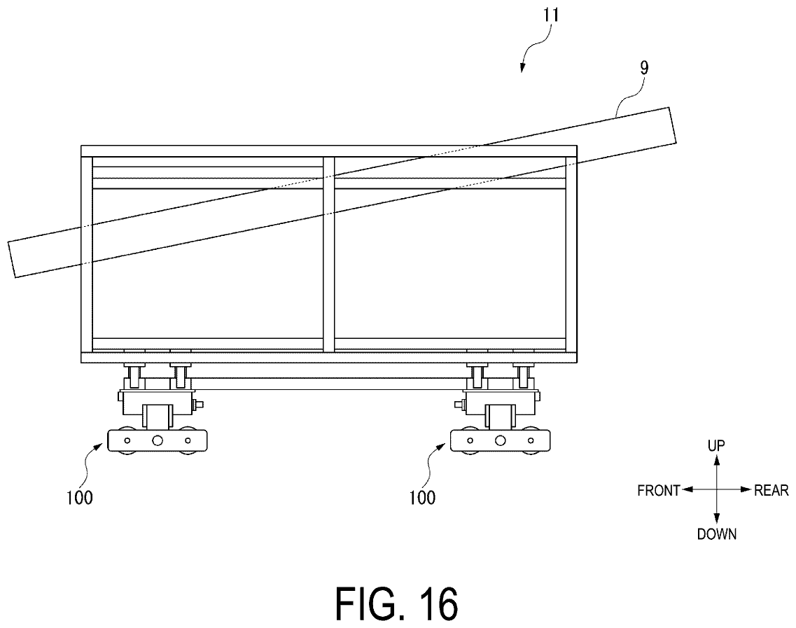

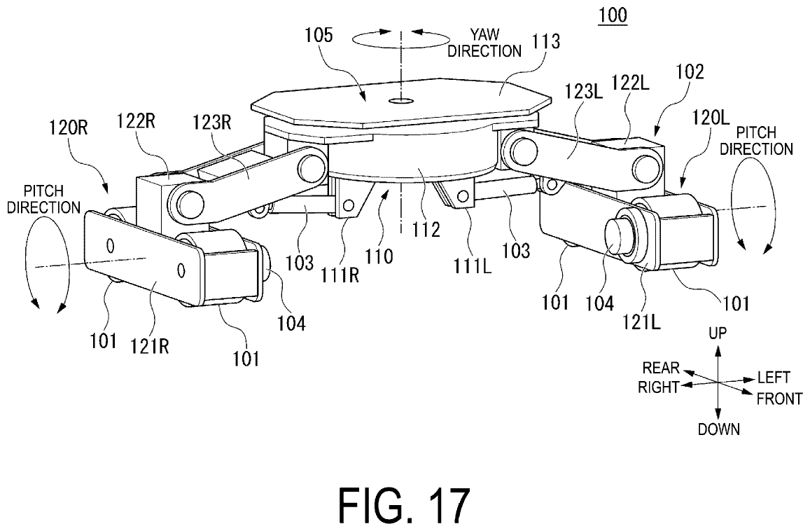

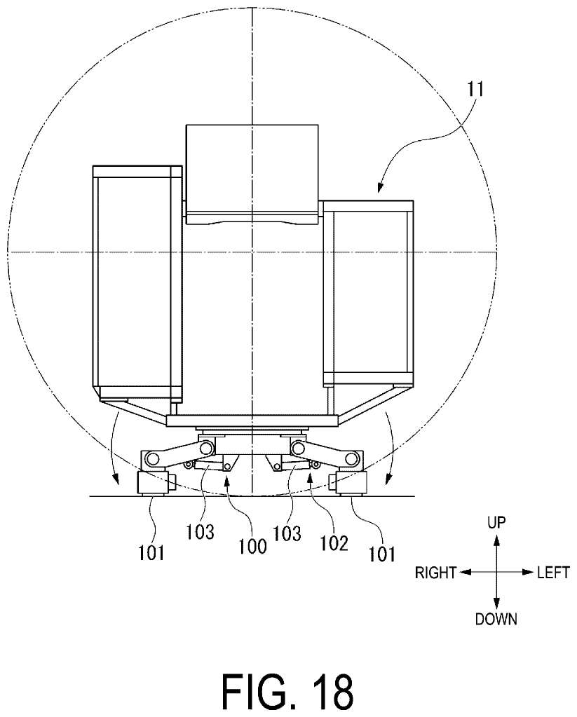

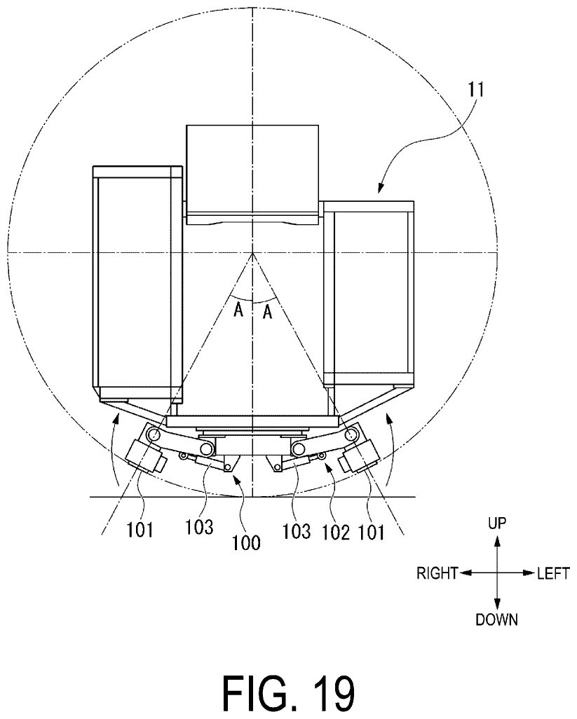

FIG. 16 is a side view of the trailing car 11 according to the first embodiment (the example of the figure illustrates the first vehicle 11 of the total of seven vehicles 11 to 17). FIG. 17 is a perspective view of the travel device 100 supporting the trailing cars 11 to 17 according to the first embodiment. FIG. 18 is a front view illustrating a state in which the travel device 100 supporting the trailing car 11 according to the first embodiment (the example of the figure illustrates the first vehicle 11 of the total of seven vehicles 11 to 17) travels on a flat road surface. FIG. 19 is a front view illustrating a state in which the travel device 100 supporting the trailing car 11 according to the first embodiment (the example of the figure illustrates the first vehicle 11 of the total of seven vehicles 11 to 17) travels on an arcuate road surface. In FIGS. 18 and 19, the flat road surface is indicated by a solid line, and the arcuate road surface is indicated by a two-dot chain line.

With reference to FIGS. 16 to 19, the tunnel boring system 1 includes the travel device 100 used for the trailing cars 11 to 17 following the boring machine 3.

As described above, a plurality of the trailing cars 11 to 17 are provided. The travel device 100 is provided at each of the plurality of trailing cars 11 to 17. Each of the plurality of travel devices 100 includes a drive device 104 for causing the travel device 100 to travel autonomously. For example, the drive device 104 is a travel motor. For example, each of the plurality of travel devices 100 may include a brake for stopping the travel device 100.

The tunnel boring system 1 includes a control device 7 that controls each of the plurality of drive devices 104 (see FIG. 1). For example, when each of the plurality of travel devices 100 includes a drive control unit that controls the drive device 104, the control device 7 may integrally control the plurality of drive control units.

In the example of the figure, the travel devices 100 are provided at a total of two locations at the trailing car 11, with one location at each of a front lower portion and a rear lower portion. Note that the number of installation locations of the travel device 100 supporting the trailing car 11 is not limited to the above, and may be one location or three locations or more.

For example, the installation location of the travel device 100 supporting the trailing car 11 can be changed according to the design specifications.

The travel device 100 includes wheels 101 and a variable mechanism 102. In the example of the figure, one travel device 100 is provided with a total of four wheels 101, with two on each of the right and left. Note that the number of the wheels 101 to be installed is not limited to the above, and may be three or less or five or more. For example, the number of the wheels 101 of the travel device 100 to be installed can be changed according to the design specifications.

The variable mechanism 102 can change the angle A formed by a line orthogonal to a rotation axis of the wheels 101 and a vertical line between a first state in which the travel device 100 travels on a flat road surface and a second state in which the travel device 100 travels on an arcuate road surface in frontal view. The first state corresponds to the state illustrated in FIG. 18. The second state corresponds to the state illustrated in FIG. 19. In the first state, the angle A is zero. In the second state, the angle A is greater than zero.

The variable mechanism 102 includes a cylinder 103 at a part of the mechanism for changing the angle A. For example, the cylinder 103 is a hydraulic cylinder. A pair of the right and left cylinders 103 are provided. The cylinder 103 may be detachably attached to a part of the variable mechanism 102.

The variable mechanism 102 changes the angle A by changing the length of the cylinder 103. For example, by extending and retracting the cylinder 103, the variable mechanism 102 can change the angle A between the first state and the second state in frontal view. In the example of FIG. 18, the wheels 101 in a state where the angle A is zero are illustrated, and in the example of FIG. 19, the wheels 101 in a case where the angle A is greater than zero are illustrated. In the example of FIG. 18, the cylinder 103 having a predetermined length is illustrated, and in the example of FIG. 19, the cylinder 103 extending longer than a predetermined length is illustrated.

The travel device 100 includes a yawing mechanism 105 that can swing the wheels 101 in a yaw direction on an up-down axis of the travel device 100. The yawing mechanism 105 is provided at a part of a swing frame structure 110. Note that the yawing mechanism 105 may include a pair of right and left yawing cylinders (not illustrated). For example, the yawing mechanism 105 may revolve by an actuator (not illustrated) such as a motor. The travel device 100 may include a rolling mechanism (not illustrated) that can swing the wheels 101 in a roll direction on a front-rear axis of the travel device 100.

The swing frame structure 110 includes lower brackets 111L and 111R, a middle body 112, and an upper plate 113.

A pair of the right and left lower brackets 111L and 111R are provided. Upper portions of the pair of right and left lower brackets 111L and 111R are fixed to a lower portion of the middle body 112.

A center portion in the front-rear and right-left directions of the middle body 112 overlaps the upper plate 113 in top view. The center portion in the front-rear and right-left directions of the middle body 112 is coupled to the upper plate 113. The middle body 112 is swingable about an axis along the up-down direction (swingable in the yaw direction) at a coupling portion with the upper plate 113 (see FIG. 17).

The travel device 100 includes pitching mechanisms 120L and 120R that can swing the wheels 101 in a pitch direction on a right-left axis of the travel device 100. A pair of the right and left pitching mechanisms 120L and 120R are provided. The pitching mechanisms 120L and 120R include pitching frames 121L and 121R and side frames 122L and 122R.

The pitching frames 121L and 121R extend along the front-rear direction. The pitching frames 121L and 121R rotatably support the wheels 101. In the example of the figure, the wheels 101 are coupled to each of the front end portion and the rear end portion of the pitching frames 121L and 121R via an axle. Each of the wheels 101 is rotatable about an axis along the right-left direction at a coupling portion with the pitching frames 121L and 121R.

Center portions in the front-rear direction of the pitching frames 121L and 121R overlap the lower portions of the side frames 122L and 122R in side view. The center portions in the front-rear direction of the pitching frames 121L and 121R are coupled to the lower portions of the side frames 122L and 122R. The pitching frames 121L and 121R are swingable about an axis along the right-left direction (swingable in the pitch direction) at coupling portions with the side frames 122L and 122R (see FIG. 17).

Upper portions of the side frames 122L and 122R overlap outer end portions in the right-left direction of the lifting and lowering links 123L and 123R in front view. A pair of the right and left lifting and lowering links 123L and 123R are provided. The upper portions of the side frames 122L and 122R are coupled to the outer end portions in the right-left direction of the lifting and lowering links 123L and 123R. The side frames 122L and 122R are swingable about an axis along the front-rear direction at a coupling portion with the lifting and lowering links 123L and 123R. The side frames 122L and 122R constitute a part of the variable mechanism 102.

Inner end portions in the right-left direction of the lifting and lowering links 123L and 123R overlap outer end portions in the right-left direction of the middle body 112 in front view. The inner end portions in the right-left direction of the lifting and lowering links 123L and 123R are coupled to the outer end portions in the right-left direction of the middle body 112. The lifting and lowering links 123L and 123R are swingable about an axis along the front-rear direction at a coupling portion with the middle body 112.

Parts projecting downward from the front and rear of the center portion in the right-left direction of the lifting and lowering links 123L and 123R (hereinafter, also called a “pair of front and rear protrusion portions”) overlap one end portion (outer end portions in the right-left direction) of the cylinder 103 in front view. The pair of front and rear protrusion portions of the lifting and lowering links 123L and 123R are coupled to the one end portion of the cylinder 103. The lifting and lowering links 123L and 123R are swingable about an axis along the front-rear direction at a coupling portion with the one end portion of the cylinder 103. The lifting and lowering links 123L and 123R constitute a part of the variable mechanism 102.

Lower portions of the lower brackets 111L and 111R overlap the other end portion (inner end portion in the right-left direction) of the cylinder 103 in front view. The lower portions of the lower brackets 111L and 111R are coupled to the other end portion of the cylinder 103. The lower brackets 111L and 111R are swingable about an axis along the front-rear direction at a coupling portion with the other end portion of the cylinder 103. The lower brackets 111L and 111R constitute a part of the variable mechanism 102.

The travel device 100 includes a mechanism (an example of the first link mechanism) including the lower brackets 111L and 111R and the cylinder 103 as the mechanism for changing the angle A, and a mechanism (an example of the second link mechanism) including the lifting and lowering links 123L and 123R. The cylinder 103 is provided at the first link mechanism so as to pass the lower portions of the lower brackets 111L and 111R constituting the first link mechanism and the pair of front and rear protrusion portions of the lifting and lowering links 123L and 123R.

For example, in a case where travel information such as a marker and a baseline is installed in advance in a room or on a room wall, the control device 7 may control each of the drive devices 104 based on the travel information described above. For example, the control device 7 may control the yawing mechanism 105, the rolling mechanism (not illustrated), the pitching mechanisms 120L and 120R, and the like in order to cause the posture of the trailing cars 11 to 17 to follow the travel information.

### Actions and Effects

As described above, the travel device 50 of the present embodiment is a travel device used for the boring machine 3. The travel device 50 includes the wheels 51, and the variable mechanism 52 that can change the angle A formed by the line orthogonal to the rotation axis of the wheels 51 and the vertical line between the first state in which the travel device 50 travels on a flat road surface and the second state in which the travel device 50 travels on an arcuate road surface in frontal view.

According to this configuration, the angle A of the wheels 51 can be changed between the first state and the second state by the variable mechanism 52. Therefore, the travel device 50 can stably travel regardless of whether the room has an arcuate road surface or has a flat road surface.

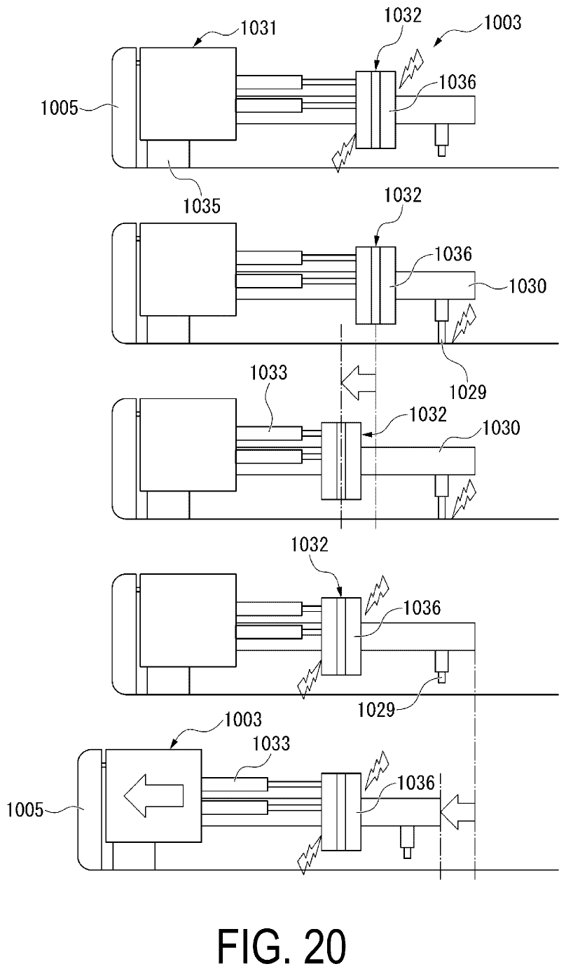

FIG. 20 is a view illustrating an example of an excavation procedure by a boring machine 1003 according to the comparative example. With reference to FIG. 20, in general, when the boring machine 1003 moves in the front-rear direction in a room, a part of the boring machine 1003 is supported. For example, in the example of the figure, excavation by the boring machine 1003 is performed in the following procedure. As illustrated in the uppermost view of FIG. 20, when the rotation of the cutter head 1005 is stopped, the vertical support 1035 of the front body 1031 is grounded, and the gripper 1036 of the rear body 1032 is overhung to the tunnel wall. Next, as illustrated in the second view from the top of FIG. 20, a rear support 1029 is overhung to support the frame 1030 attached with the rear body 1032, and the gripper 1036 fixed to the tunnel wall of the tunnel is loosened. Next, as illustrated in the third view from the top of FIG. 20, the extension-retraction mechanism 1033 is retracted to a predetermined distance, and the rear body 1032 is moved forward in the arrow direction by sliding on the frame 1030. Next, as illustrated in the fourth view from the top of FIG. 20, the gripper 1036 of the rear body 1032 is overhung to the tunnel wall, and the overhung rear support 1029 is loosened. Next, as illustrated in the lowermost view from the top in FIG. 20, while rotating the cutter head 1005, a reaction force is obtained from the gripper 1036 that is overhung, and the extension-retraction mechanism 1033 is extended to a predetermined distance. By this, the boring machine 1003 excavates in the arrow direction. As described above, in the comparative example, the rear support 1029 is necessary when the boring machine 1003 moves in the front-rear direction in the room.

On the other hand, according to the present configuration, since the travel device 50 is used for the boring machine 3, the rear support 1029 can be eliminated when the boring machine 3 moves in the front-rear direction in the room.

The boring machine 3 of the present embodiment includes the front body 31 to which the cutter head 5 for boring borings is attached, the rear body 32 connected to the front body 31 via the extension-retraction mechanism 33, and the travel device 50 described above. The travel device 50 is provided at each of the front body 31 and the rear body 32.

According to this configuration, by supporting the rear body 32 by the travel device 50, the rear body 32 can be moved forward by sliding on the frame. Therefore, when the rear body 32 is moved forward, it is not necessary to overhang the rear support 1029 to support the frame 1030 attached with the rear body 32. Therefore, the rear support 1029 can be eliminated.

For example, a known TBM requires a rail when not only the trailing cars but also the front body and the rear body are retreated after boring. Therefore, the rail is manually set behind while the forward boring is performed by the cutter head. On the other hand, according to the present configuration, since the front body 31 and the rear body 32 are supported by the travel device 50, rails for movement are unnecessary in both the front body 31 and the rear body 32.

Therefore, the rail installation work performed in parallel with the boring work by the TBM is unnecessary.

The trailing cars 11 to 17 of the present embodiment are the trailing cars 11 to 17 following the boring machine 3.

Each of the trailing cars 11 to 17 includes the travel device 100 described above.

According to this configuration, by supporting the trailing cars 11 to 17 by the travel device 100, the trailing cars 11 to 17 can stably travel regardless of whether the room has an arcuate road surface or has a flat road surface. In addition, a rail facility for supporting the trailing cars 11 to 17 is unnecessary. Therefore, raillessness can be achieved.

The tunnel boring system 1 of the present embodiment includes the boring machine 3, the trailing cars 11 to 17 following the boring machine 3, and the travel device 50 described above. The travel device 50 is provided at each of the boring machine 3 and the trailing cars 11 to 17.

According to this configuration, by supporting each of the boring machine 3 and the trailing cars 11 to 17 by the travel device 50, each of the boring machine 3 and the trailing cars 11 to 17 can stably travel regardless of whether the room has an arcuate road surface or has a flat road surface. In addition, the rear support 1029 can be eliminated when the tunnel boring system 1 moves in the front-rear direction in the room.

In the present embodiment, the travel device 50 includes the yawing mechanism 55 that can swing the wheels 51 in the yaw direction on the up-down axis of the travel device 50, the rolling mechanism 57 that can swing the wheels 51 in the roll direction on the front-rear axis of the travel device 50, and the pitching mechanisms 70L and 70R that can swing the wheels 51 in the pitch direction on the right-left axis of the travel device 50.

According to this configuration, the yawing mechanism 55, the rolling mechanism 57, and the pitching mechanisms 70L and 70R can cause the posture of the travel device 50 to follow the road surface regardless of the shape of the road surface on which the travel device 50 moves. This can move the travel device 50 smoothly.

In the present embodiment, the variable mechanism 52 of the travel device 50 used for the boring machine 3 includes the rod 53 in a part of the mechanism for changing the angle A.

According to this configuration, the angle A of the wheels 51 can be changed between the first state and the second state with a simple configuration in which the variable mechanism 52 includes the rod 53. For example, the angle A can be easily changed by preparing in advance a plurality of rods 53 having different lengths from each other and replacing the rods 53 at a desired timing.

In the present embodiment, the variable mechanism 52 changes the angle A by switching between the rods 53A and 53B having different lengths from each other as the rod 53.

According to this configuration, the angle A can be easily changed by replacing the rods 53A and 53B at a desired timing.

In the present embodiment, the travel device 50 includes a mechanism (an example of the first link mechanism) including the rod 53 as the mechanism for changing the angle A, and a mechanism (an example of the second link mechanism) including the lower frame 61 and the side frames 72L and 72R to which the one end portion of the rod 53 is connected. By fixing the lengths of the lower frame 61 and the side frames 72L and 72R (an example of the length of the second link mechanism) and switching between the rods 53A and 53B having different lengths from each other as the rods 53, the variable mechanism 52 changes the length of the rod 53 (an example of the length of the first link mechanism) connected to the outer end portion in the right-left direction of the upper portion of the lower frame 61 and the pair of front and rear protrusion portions of the side frames 72L and 72R.

According to this configuration, the angle A can be easily changed by changing the length of a part of the mechanism for changing the angle A (a part of the first link mechanism).

In the present embodiment, the variable mechanism 102 provided at the trailing cars 11 to 17 includes the cylinder 103 at a part of the mechanism for changing the angle A.

According to this configuration, the angle A of the wheels 101 can be changed between the first state and the second state with a simple configuration in which the variable mechanism 102 includes the cylinder 103. For example, the angle A can be easily changed by extending and retracting the cylinder 103 at a desired timing.

In the present embodiment, the variable mechanism 102 changes the angle A by changing the length of the cylinder 103.

According to this configuration, the angle A can be easily changed by changing the length of the cylinder 103 at a desired timing.

The present embodiment includes a mechanism (an example of the first link mechanism) including the lower brackets 111L and 111R and the cylinder 103 as the mechanism for changing the angle A, and a mechanism (an example of the second link mechanism) including the lifting and lowering links 123L and 123R. The cylinder 103 is provided at the first link mechanism so as to pass the lower portions of the lower brackets 111L and 111R constituting the first link mechanism and the pair of front and rear protrusion portions of the lifting and lowering links 123L and 123R.

According to this configuration, the angle A can be easily changed by providing the cylinder 103 (at the first link mechanism) so as to pass the lower portions of the lower brackets 111L and 111R and the pair of front and rear protrusion portions of the lifting and lowering links 123L and 123R.

In the present embodiment, the cutter head 5 includes the attachment portion 49 for the travel device 50.

According to this configuration, the travel device 50 can be attached to the attachment portion 49 of the cutter head 5. Therefore, by supporting the front body 31 by the travel device 50 via the cutter head 5, a rail for movement is unnecessary in the front body 31.

The movement method of the present embodiment is a movement method for moving the boring machine 3 including the front body 31 to which the cutter head 5 for boring borings is attached, the rear body 32 connected to the front body 31 via the extension-retraction mechanism 33, the vertical support 35 (an example of the front body self-weight support mechanism) provided at the front body, the grippers 36 and 37 (an example of the rear body gripper) provided at the rear body 32, and the travel device 50. The movement method includes a rear body fixing step of fixing the rear body 32 to a tunnel by the grippers 36 and 37, a front body self-weight supporting step of grounding the vertical support 35 and supporting the self-weight of the front body 31 after the rear body fixing step, a forward-moving boring step of moving the front body 31 forward and performing boring by the cutter head 5 after the front body self-weight supporting step, a rear-body travel device grounding step of releasing the grippers 36 and 37 and grounding the travel device 50 provided at the rear body 32 after the forward-moving boring step, and a rear body forward-moving step of retracting the extension-retraction mechanism 33 to move the rear body 32 forward together with the travel device 50 after the rear-body travel device grounding step.

According to this method, after the rear body travel device grounding step, by retracting the extension-retraction mechanism 33 and moving the rear body 32 forward together with the travel device 50, the rear body 32 can stably travel regardless of whether the room has an arcuate road surface or has a flat road surface. In addition, the rear support 1029 can be eliminated when the boring machine 3 moves in the front-rear direction in the room.

The movement method of the present embodiment is a movement method for moving the boring machine 3 including the front body 31 to which the cutter head 5 for boring borings is attached, the rear body 32 connected to the front body 31 via the extension-retraction mechanism 33, and the travel device 50. In the movement method, after the boring of the tunnel by the cutter head 5 is completed, the boring machine 3 is moved rearward by an allowable distance for the travel device 50 at least between the tunnel wall in front of the cutter head 5 and the cutter head 5, and after the cutter head 5 is attached with the travel device 50, the boring machine 3 is retreated.

According to this method, by retreating the boring machine 3 after attaching the travel device 50 to the cutter head 5, a rail for movement is unnecessary in the boring machine 3.

In the present embodiment, the plurality of trailing cars 11 to 17 are provided. The travel device 100 is provided at each of the plurality of trailing cars 11 to 17. Each of the plurality of travel devices 100 includes a drive device 104 for causing the travel device 100 to travel autonomously.

According to this configuration, the drive device 104 can cause the trailing cars 11 to 17 supported by each of the travel devices 100 to autonomously travel. Therefore, a coupling member for coupling each of the plurality of trailing cars 11 to 17 is unnecessary.

In the present embodiment, the tunnel boring system 1 includes the control device 7 that controls each of the plurality of drive devices 104.

According to this configuration, by controlling each of the drive devices 104, it is possible to perform what is called vehicle platooning in which each of the trailing cars 11 to 17 travels while maintaining a predetermined interval without colliding with each other. On the other hand, when the trailing cars 11 to 17 are coupled to each other via an elastic body, the speed of the trailing cars 11 to 17 can be controlled so that the elastic body is not applied with an excessive load by controlling each of the drive devices 104.

The steering can be controlled by a yawing actuator not illustrated while detecting the center of the room.

Note that it is also possible to travel while detecting not only the center of the room, but also the center of a planned track that is a target set in a wide area such as an assembly site.

### Second Embodiment

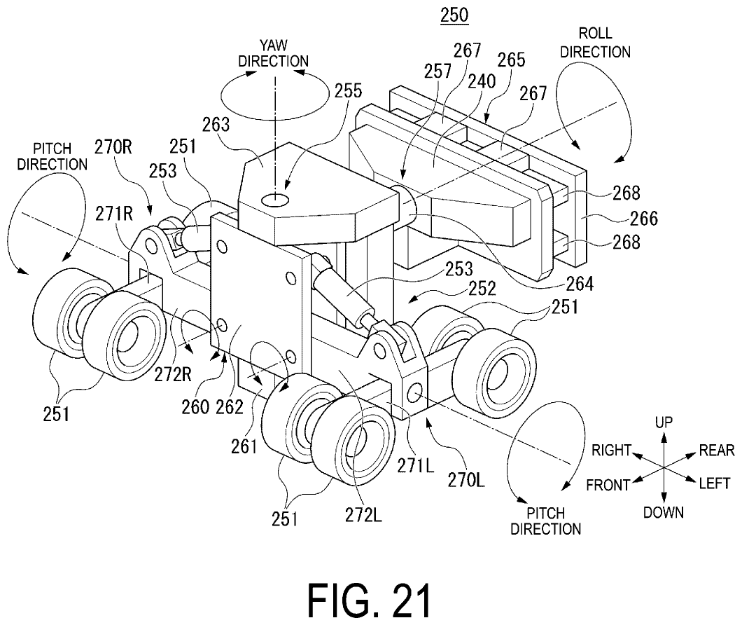

In the first embodiment, an example in which the variable mechanism 52 of the travel device 50 used for the boring machine 3 includes the rod 53 at a part of the mechanism for changing the angle A (see FIG. 6) has been described. As illustrated in FIG. 21, the second embodiment is different from the first embodiment in that a variable mechanism 252 of a travel device 250 includes a cylinder 253 at a part of the mechanism for changing the angle A.

FIG. 21 is a perspective view of the travel device 250 according to the second embodiment.

With reference to FIG. 21, the travel device 250 includes wheels 251 and the variable mechanism 252. For example, one travel device 250 is provided with a total of eight wheels 251, with four on each of the right and left. Note that the number of the wheels 251 to be installed is not limited to the above, and may be seven or less or nine or more. For example, the number of the wheels 251 of the travel device 250 to be installed can be changed according to the design specifications.

The variable mechanism 252 can change the angle A formed by a line orthogonal to a rotation axis of the wheels 251 and a vertical line between a first state in which the travel device 250 travels on a flat road surface and a second state in which the travel device 250 travels on an arcuate road surface in frontal view. The first state corresponds to the state illustrated in FIG. 2. The second state corresponds to the state illustrated in FIG. 3.

The variable mechanism 252 includes the cylinder 253 at a part of the mechanism for changing the angle A. For example, the cylinder 253 is a hydraulic cylinder. A pair of the right and left cylinders 253 are provided. The cylinder 253 may be detachably attached to a part of the variable mechanism 252. The variable mechanism 252 changes the angle A by changing the length of the cylinder 253. For example, by extending and retracting the cylinder 253, the variable mechanism 252 can change the angle A between the first state and the second state in frontal view.

The travel device 250 includes a yawing mechanism 255 that can swing the wheels 251 in a yaw direction on an up-down axis of the travel device 250. The yawing mechanism 255 is provided at a part of a center frame structure 260. For example, the yawing mechanism 255 may include a pair of right and left yawing cylinders (not illustrated). For example, the yawing mechanism 255 may revolve by an actuator (not illustrated) such as a motor.

The travel device 250 includes a rolling mechanism 257 that can swing the wheels 251 in a roll direction on a front-rear axis of the travel device 250. The rolling mechanism 257 is provided at a part of the center frame structure 260.

The center frame structure 260 includes a lower block 261, a middle block 262, and an upper block 263.

A front portion of the upper block 263 overlaps an upper portion of the middle block 262 in top view. The front portion of the upper block 263 is coupled to the upper portion of the middle block 262. The upper block 263 is swingable about an axis along the up-down direction (swingable in the yaw direction) at a coupling portion with the middle block 262.

In the example of the figure, a rear portion of the center frame structure 260 is coupled to a front portion of a coupling block 240 via a shaft 264. The center frame structure 260 is swingable about an axis along the front-rear direction (swingable in the roll direction) at a coupling portion with the coupling block 240.

The travel device 250 includes pitching mechanisms 270L and 270R that can swing the wheels 251 in a pitch direction on a right-left axis of the travel device 250. A pair of the right and left pitching mechanisms 270L and 270R are provided. The pitching mechanisms 270L and 270R include pitching frames 271L and 271R and side frames 272L and 272R.

The pitching frames 271L and 271R extend along the front-rear direction. The pitching frames 271L and 271R rotatably support the wheels 251. In the example of the figure, a pair of the right and left wheels 251 are coupled to each of the front end portion and the rear end portion of the pitching frames 271L and 271R via an axle. Each of the wheels 251 is rotatable about an axis along the right-left direction at a coupling portion with the pitching frames 271L and 271R.

Center portions in the front-rear direction of the pitching frames 271L and 271R overlap outside portions in the right-left direction of the side frames 272L and 272R in side view. The center portions in the front-rear direction of the pitching frames 271L and 271R are coupled to the outside portions in the right-left direction of the side frames 272L and 272R. The pitching frames 271L and 271R are swingable about an axis along the right-left direction (swingable in the pitch direction) at coupling portions with the side frames 272L and 272R.

Inner end portions in the right-left direction of the side frames 272L and 272R overlap an outside portion in the right-left direction of the lower portion of the middle block 262 in front view. The inner end portions in the right-left direction of the side frames 272L and 272R are coupled to the outside portion in the right-left direction of the lower portion of the middle block 262. The side frames 272L and 272R are swingable about an axis along the front-rear direction at a coupling portion with the middle block 262. The side frames 272L and 272R constitute a part of the variable mechanism 252.

Parts projecting upward from the front and rear of outside portions in the right-left direction of the side frames 272L and 272R (hereinafter also called a “pair of front and rear protrusion portions”) overlap one end portion (outer end portions in the right-left direction) of the cylinder 253 in front view. The pair of front and rear protrusion portions of the side frames 272L and 272R are coupled to the one end portion of the cylinder 253. The side frames 272L and 272R are swingable about an axis along the front-rear direction at a coupling portion with the one end portion of the cylinder 253.

The outside portion in the right-left direction of the upper portion of the middle block 262 overlaps the other end portion (inner end portion in the right-left direction) of the cylinder 253 in front view. The outside portion in the right-left direction of the upper portion of the middle block 262 is coupled to the other end portion of the cylinder 253. The middle block 262 is swingable about an axis along the front-rear direction at a coupling portion with the other end portion of the cylinder 253. The middle block 262 constitutes a part of the variable mechanism 252.

The travel device 250 includes a mechanism (an example of the first link mechanism) including the middle block 262 and the side frames 272L and 272R as the mechanism for changing the angle A, and a mechanism (an example of the second link mechanism) including the pitching frames 271L and 271R. The cylinder 253 is provided at the first link mechanism so as to pass the outside portion in the right-left direction of the upper portion of the middle block 262 constituting the first link mechanism and the pair of front and rear protrusion portions of the side frames 272L and 272R.

The travel device 250 includes a slider mechanism 265 that can move the wheels 251 in the right-left direction of the travel device 250. The slider mechanism 265 is provided at a rear portion of the coupling block 240. The slider mechanism 265 includes a slider plate 266 having a rectangular shape in front view, a slider guide 267 provided at a front surface of the slider plate 266, and a slider rail 268 provided at a rear portion of the coupling block 240.

A plurality of the slider guides 267 are provided. For example, a total of four slider guides 267 (two on the upper front surface are illustrated in the example of the figure) are provided at the slider plate 266, with two on each of the right and left on an upper front surface and a lower front surface. Note that the number of the slider guides 267 to be installed is not limited to the above, and can be changed according to the design specifications.

A plurality of the slider rails 268 are provided. In the example of the figure, a total of two slider rails 268 are provided at the coupling member 268, with one on each of an upper rear surface and a lower rear surface. Note that the number of the slider rails 268 to be installed is not limited to the above, and can be changed according to the design specifications.

For example, the travel device 250 may be attached to a front lower portion of the boring machine 3 via the slider plate 266. Note that the travel device 250 may be attached to another portion of the boring machine 3 not via the slider plate 266. For example, the slider plate 266 may be detachably attached to the rear portion of the travel device 250.

### Actions and Effects

In the second embodiment, the variable mechanism 252 includes the cylinder 253 at a part of the mechanism for changing the angle A.

According to this configuration, the angle A of the wheels 251 can be changed between the first state and the second state with a simple configuration in which the variable mechanism 252 includes the cylinder 253. For example, the angle A can be easily changed by extending and retracting the cylinder 253 at a desired timing.

### Third Embodiment

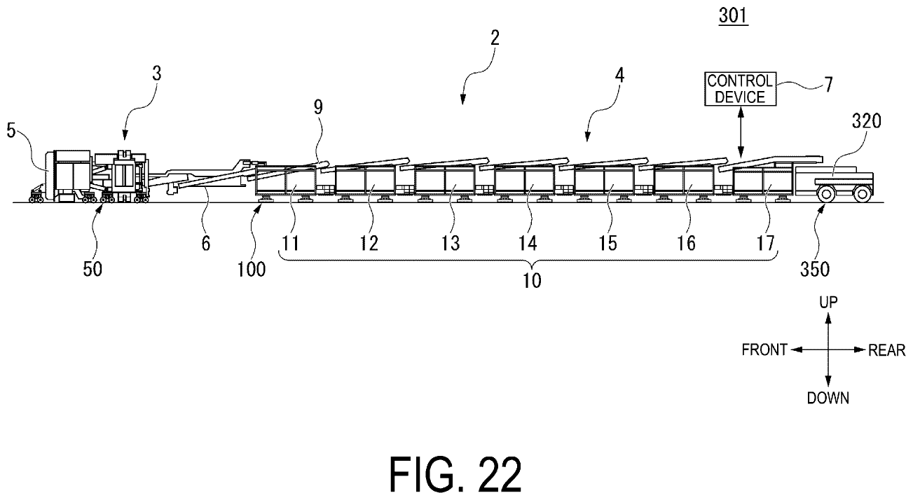

In the first embodiment, an example in which each of the boring machine 3 and the trailing cars 11 to 17 constituting the tunnel boring system 1 includes the travel device (see FIGS. 1 and 2) has been described. As illustrated in FIG. 22, the third embodiment is different from the first embodiment in that an underground transport vehicle 320 (an example of the transport vehicle) that transports borings includes a travel device 350.

FIG. 22 is a side view of a tunnel boring system 301 according to the third embodiment. With reference to FIG. 22, the tunnel boring system 301 includes the travel device 50 used for the boring machine 3, the travel device 100 used for the trailing cars 11 to 17, and the travel device 350 used for the underground transport vehicle 320.

### Travel Device Used for Underground Transport Vehicle

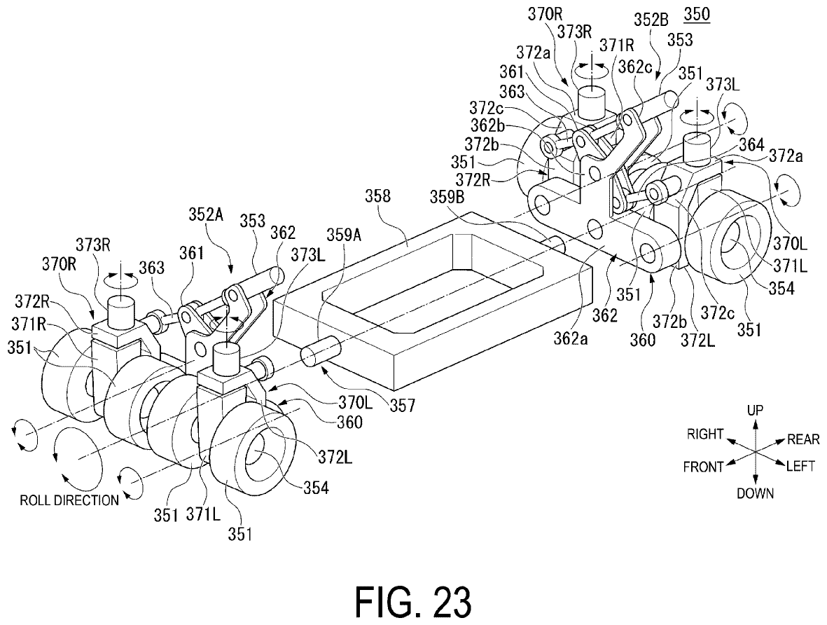

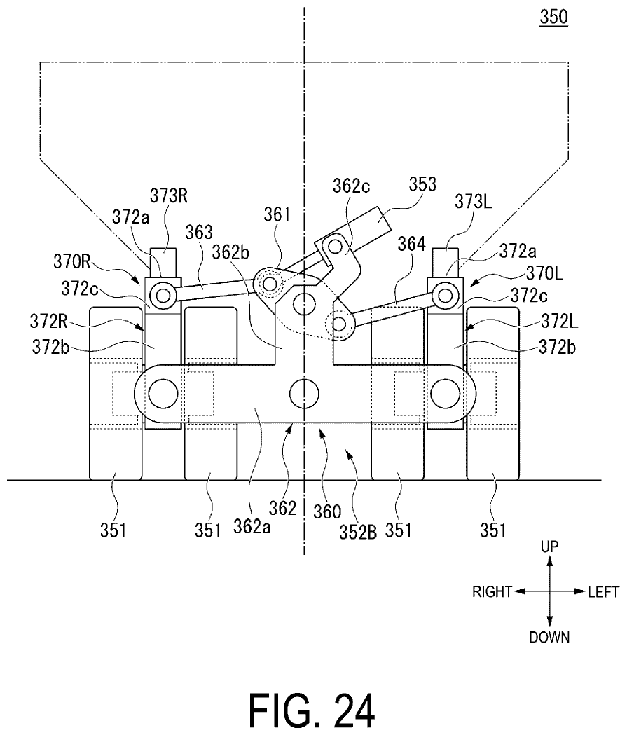

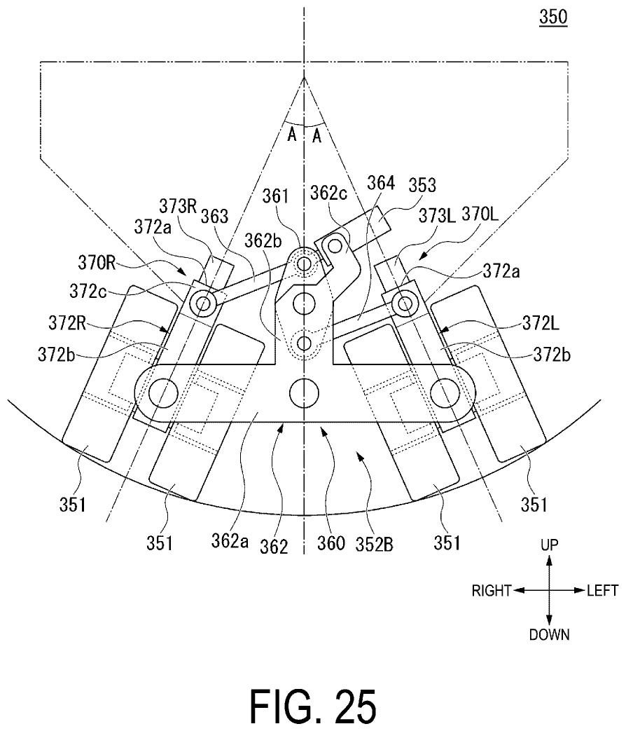

FIG. 23 is a perspective view of the travel device 350 according to the third embodiment. FIG. 24 is a front view illustrating a state in which the travel device 350 according to the third embodiment travels on a flat road surface. FIG. 25 is a front view illustrating a state in which the travel device 350 according to the third embodiment travels on an arcuate road surface. In FIGS. 24 and 25, the main body of the underground transport vehicle is indicated by a two-dot chain line.

With reference to FIGS. 23 to 25, the travel device 350 includes wheels 351, a pair of front and rear variable mechanisms 352A and 352B (a front variable mechanism 352A and a rear variable mechanism 352B), and a carrier frame 358. For example, one travel device 350 is provided with a total of eight wheels 351, with four on each of the right and left (specifically, two on each of the right and left on the front side and two on each of the right and left on the rear side). Note that the number of the wheels 351 to be installed is not limited to the above, and may be seven or less or nine or more. For example, the number of the wheels 351 of the travel device 350 to be installed can be changed according to the design specifications.

The travel device 350 includes a drive device 354 for causing the travel device 350 to travel autonomously. For example, the drive device 354 is a travel motor. For example, the drive device 354 is an in-wheel motor built in wheels of the wheels 351. For example, the drive device 354 is provided at each of the plurality of wheels 351. For example, the travel device 350 may include a brake for stopping the travel device 350. Note that the drive device 354 does not need to be provided at each of the plurality of wheels 351. For example, the travel device 350 may include only an axle without including the drive device 354. For example, the installation mode of the drive device 354 can be changed according to the design specifications.

The control device 7 controls the drive device 354. For example, when the travel device 350 includes a plurality of drive control units that control the respective drive devices 354, the control device 7 may integrally control the plurality of drive control units.

In the example of the figure, the carrier frame 358 is formed in a rectangular frame shape having a longitudinal side in the front-rear direction in top view. Note that the shape of the carrier frame 358 is not limited to the above, and may be a rectangular frame shape having a longitudinal side in the right-left direction in top view. For example, the shape of the carrier frame 358 may be formed in a rectangular cuboid shape in top view. For example, the shape of the carrier frame 358 can be changed according to the design specifications.

The variable mechanisms 352A and 352B can change the angle A formed by a line orthogonal to a rotation axis of the wheels 351 and a vertical line between a first state in which the travel device 350 travels on a flat road surface and a second state in which the travel device 350 travels on an arcuate road surface in frontal view. The first state corresponds to the state illustrated in FIG. 24. The second state corresponds to the state illustrated in FIG. 25. Note that FIGS. 24 and 25 illustrate the frontal view (front view) of the rear variable mechanism 352B.

The variable mechanisms 352A and 352B include a cylinder 353 at a part of the mechanism for changing the angle A. For example, the cylinder 353 is a hydraulic cylinder. One cylinder 353 is provided in each of the front variable mechanism 352A and the rear variable mechanism 352B. The cylinder 353 may be detachably attached to a part of the variable mechanisms 352A and 352B. The variable mechanisms 352A and 352B change the angle A by changing the length of the cylinder 353. For example, by extending and retracting the cylinder 353, the variable mechanisms 352A and 352B can change the angle A between the first state and the second state in frontal view.

The travel device 350 includes a rolling mechanism 357 that can swing the wheels 351 in a roll direction on a front-rear axis of the travel device 350. The rolling mechanism 357 is provided at a part of a bell crank mechanism 360 (e.g., a part of the bell crank mechanism 360 of the front variable mechanism 352A).

The bell crank mechanism 360 includes a bell crank 361, a sub frame 362, an upper link 363, and a lower link 364.

The bell crank 361 has a longitudinal side in a direction intersecting the right-left direction in front view. In the example of FIG. 24 (first state), the bell crank 361 is tilted such that a right end portion of the bell crank 361 is positioned upward and a left end portion of the bell crank 361 is positioned downward in front view. In the example of FIG. 25 (second state), the bell crank 361 is arranged along the up-down direction in front view.

The sub frame 362 includes a right-left extension portion 362a extending in the right-left direction in front view, a center extension portion 362b extending upward from a center portion in the right-left direction of the right-left extension portion 362a, and an upward extension portion 362c extending leftward and upward from an upper end portion of the center extension portion 362b and then extending rightward and upward. The right-left extension portion 362a overlaps the carrier frame 358 in front view.

A center portion in the longitudinal direction of the bell crank 361 overlaps an upper portion of the center extension portion 362b of the sub frame 362 in front view. The center portion in the longitudinal direction of the bell crank 361 is coupled to the upper portion of the center extension portion 362b of the sub frame 362. The bell crank 361 is swingable about an axis along the front-rear direction at a coupling portion with the sub frame 362.

The upper link 363 has a longitudinal side in a direction intersecting the right-left direction in front view. Specifically, the upper link 363 is tilted such that an inner end portion in the right-left direction of the upper link 363 is positioned upward and an outer end portion (right end portion) in the right-left direction of the upper link 363 is positioned downward in front view.

The inner end portion in the right-left direction of the upper link 363 overlaps one end portion (the right end portion in the example of FIG. 24 and the upper end portion in the example of FIG. 25) of the bell crank 361 in front view. The inner end portion in the right-left direction of the upper link 363 is coupled to the one end portion of the bell crank 361. An inner end portion in the right-left direction of the upper link 363 is swingable about an axis along the front-rear direction at a coupling portion with the bell crank 361. A coupling portion between the upper link 363 and the bell crank 361 is arranged more upward than the coupling portion between the bell crank 361 and the sub frame 362 in front view.

The lower link 364 has a longitudinal side in a direction intersecting the right-left direction in front view. Specifically, the lower link 364 is tilted such that an outer end portion (left end portion) in the right-left direction of the lower link 364 is positioned upward and an inner end portion in the right-left direction of the lower link 364 is positioned downward in front view.

The inner end portion in the right-left direction of the lower link 364 overlaps the other end portion (left end portion in example of FIG. 24 and lower end portion in example of FIG. 25) of the bell crank 361 in front view. The inner end portion in the right-left direction of the lower link 364 is coupled to the other end portion of the bell crank 361. The inner end portion in the right-left direction of the lower link 364 is swingable about an axis along the front-rear direction at a coupling portion with the bell crank 361. A coupling portion between the lower link 364 and the bell crank 361 is arranged more downward than the coupling portion between the bell crank 361 and the sub frame 362 in front view.

In the example of the figure, a rear end portion of a swing shaft 359A extending in the front-rear direction is coupled to the center portion in the right-left direction of a front portion of the carrier frame 358. A front end portion of a fixing shaft 359B extending in the front-rear direction is coupled to the center portion in the right-left direction of a rear portion of the carrier frame 358.

In the example of the figure, a lower center portion (a center portion in the right-left direction of the right-left extension portion 362a) of the sub frame 362 in the front variable mechanism 352A is coupled to the front portion of the carrier frame 358 via the swing shaft 359A. The front variable mechanism 352A is swingable about an axis along the front-rear direction (swingable in the roll direction) at a coupling portion with the carrier frame 358.

In the example of the figure, the lower center portion (the center portion in the right-left direction of the right-left extension portion 362a) of the sub frame 362 in the rear variable mechanism 352B is fixed to the rear portion of the carrier frame 358 via the fixing shaft 359B. The rear variable mechanism 352B is not swingable (not swingable in the roll direction) about the axis along the front-rear direction at the coupling portion with the carrier frame 358.

Note that the swing mode of the front variable mechanism 352A and the rear variable mechanism 352B at the coupling portion with the carrier frame 358 is not limited to the above. For example, the lower center portion (the center portion in the right-left direction of the right-left extension portion 362a) of the sub frame 362 in the front variable mechanism 352A may be fixed to the front portion of the carrier frame 358 via the fixing shaft 359B. For example, the front variable mechanism 352A may not be swingable (not be swingable in the roll direction) about the axis along the front-rear direction at the coupling portion with the carrier frame 358.

For example, the lower center portion (the center portion in the right-left direction of the right-left extension portion 362a) of the sub frame 362 in the rear variable mechanism 352B may be coupled to the rear portion of the carrier frame 358 via the swing shaft 359A. For example, the rear variable mechanism 352B may be swingable (swingable in the roll direction) about the axis along the front-rear direction at the coupling portion with the carrier frame 358. For example, the swing mode the front variable mechanism 352A and the rear variable mechanism 352B at the coupling portion with the carrier frame 358 can be changed according to the design specifications.

The travel device 350 includes steering mechanisms 370L and 370R steerably supporting the wheels 351. A pair of the right and left steering mechanisms 370L and 370R are provided.

The steering mechanisms 370L and 370R include axle supports 371L and 371R, camber arms 372L and 372R, and steering gear boxes 373L and 373R.

The axle supports 371L and 371R extend along the up-down direction in the first state.

The axle supports 371L and 371R rotatably support the wheels 351. In the example of the figure, a pair of the right and left wheels 351 are coupled to the lower portions of the axle supports 371L and 371R via an axle. Each of the wheels 351 is rotatable about an axis along the right-left direction at coupling portions with the axle supports 371L and 371R.

The camber arms 372L and 372R include upper arm portions 372a to which the steering gear boxes 373L and 373R are coupled on upper sides of the axle supports 371L and 371R, lower arm portions 372b to which outside portions in the right-left direction of the lower portion of the sub frame 362 are coupled on an inner side in the front-rear direction of the axle supports 371L and 371R, and intermediate arm portions 372c to which outer end portions in the right-left direction of the respective links 363 and 364 are coupled between the upper arm portion 372a and the lower arm portion 372b.

The upper arm portions 372a of the camber arms 372L and 372R overlap upper portions of the axle supports 371L and 371R in top view. The upper arm portions 372a of the camber arms 372L and 372R are coupled to the upper portions of the axle supports 371L and 371R. The camber arms 372L and 372R are swingable about an axis along the up-down direction at the coupling portions with the axle supports 371L and 371R. The steering gear boxes 373L and 373R are arranged on axes on which the axle supports 371L and 371R can swing.

Lower portions of the lower arm portions 372b of the camber arms 372L and 372R overlap outside portions in the right-left direction of the lower portion of the sub frame 362 (outside portion in the right-left direction of the right-left extension portion 362a) in front view. The lower portions of the lower arm portions 372b of the camber arms 372L and 372R are coupled to the outside portions in the right-left direction of the lower portion of the sub frame 362. The lower arm portion 372b of each of the camber arms 372L and 372R is swingable about an axis along the front-rear direction at a coupling portion with the sub frame 362.

The intermediate arm portions 372c of the camber arms 372L and 372R overlap the outside portion in the right-left direction of the respective links 363 and 364 in front view. The intermediate arm portions 372c of the camber arms 372L and 372R are coupled to the outside portion in the right-left direction of the respective links 363 and 364 in front view. The intermediate arm portion 372c of the camber arms 372L and 372R is swingable about an axis along the front-rear direction at a coupling portion with the respective links 363 and 364. The camber arms 372L and 372R constitute a part of the variable mechanisms 352A and 352B.

A part of the cylinder 353 (a tubular portion accommodating a piston of the cylinder 353 in the example of the figure) overlaps an upper portion of the upward extension portion 362c of the sub frame 362 in front view. A part of the cylinder 353 is coupled to the upper portion of the upward extension portion 362c of the sub frame 362. The cylinder 353 is swingable about an axis along the front-rear direction at a coupling portion with the sub frame 362.

The one end portion (the right end portion in the example of FIG. 24 and the upper end portion in the example of FIG. 25) of the bell crank 361 overlaps one end portion (a tip end portion of the piston of the cylinder 353 in the example of the figure) of the cylinder 353 in front view. The one end portion of the bell crank 361 is coupled to the one end portion of the cylinder 353. The bell crank 361 is swingable about an axis along the front-rear direction at a coupling portion with the cylinder 353. The bell crank 361 constitutes a part of the variable mechanisms 352A and 352B.

The travel device 350 includes a mechanism (an example of the first link mechanism) including the sub frame 362 and the cylinder 353 as the mechanism for changing the angle A, and a mechanism (an example of the second link mechanism) including the bell crank 361 and the camber arms 372L and 372R. The cylinder 353 is provided in the first link mechanism so as to pass the upper portion of the upward extension portion 362c of the sub frame 362 constituting the first link mechanism and one end portion of the bell crank 361.

### Actions and Effects

The underground transport vehicle 320 of the third embodiment is a transport vehicle that transports borings. The underground transport vehicle 320 includes the travel device 350 described above.

According to this configuration, by supporting the underground transport vehicle 320 by the travel device 350, the underground transport vehicle 320 can stably travel regardless of whether the room has an arcuate road surface or has a flat road surface. In addition, a rail facility for supporting the underground transport vehicle 320 is unnecessary.

The tunnel boring system 301 of the third embodiment includes the boring machine 3, the trailing cars 11 to 17 following the boring machine 3, and the underground transport vehicle 320 that transports borings, and the travel device 50, 100, or 350 is provided at each of the boring machine 3, the trailing cars 11 to 17, and the underground transport vehicle 320.

According to this configuration, by supporting each of the boring machine 3, the trailing cars 11 to 17, and the underground transport vehicle 320 by the travel device 50, 100, or 350, each of the boring machine 3, the trailing cars 11 to 17, and the underground transport vehicle 320 can stably travel regardless of whether the room has an arcuate road surface or has a flat road surface. In addition, the rear support 1029 can be eliminated when the tunnel boring system 301 moves in the front-rear direction in the room.

In the third embodiment, the variable mechanisms 352A and 352B include the cylinder 353 at a part of the mechanism for changing the angle A.

According to this configuration, the angle A of the wheels 351 can be changed between the first state and the second state with a simple configuration in which the variable mechanisms 352A and 352B include the cylinder 353. For example, the angle A can be easily changed by extending and retracting the cylinder 353 at a desired timing.

### Fourth Embodiment

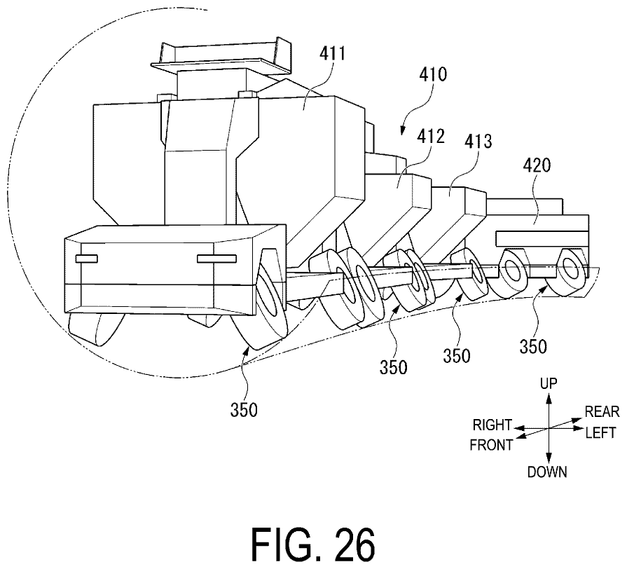

In the third embodiment, an example in which each of the boring machine 3, the trailing cars 11 to 17, and the underground transport vehicle 320 constituting the tunnel boring system 301 includes the travel device (see FIG. 22) has been described. As illustrated in FIG. 26, the fourth embodiment is different from the third embodiment in that each vehicle (an example of the transport vehicle) of a transport vehicle group 410 that transports borings includes the travel device 350.

FIG. 26 is a perspective view illustrating the transport vehicle group 410 according to the fourth embodiment. In FIG. 26, the arcuate road surface is indicated by a two-dot chain line.

In the example of the figure, the transport vehicle group 410 includes a total of three vehicles from a first vehicle 411 to a third vehicle 413.

With reference to FIG. 26, the travel device 350 is provided at each vehicle 411, 412, and 413 of the transport vehicle group 410 and each underground transport vehicle 420 (an example of the transport vehicle).

Note that the underground transport vehicle 420 may function as a traction vehicle that can pull the transport vehicle group 410. For example, the underground transport vehicle 420 may be swingably coupled to the third vehicle 413. For example, the coupling mode between the transport vehicle group 410 and the underground transport vehicle 420 can be changed according to the design specifications.

For example, the drive device 354 described above need not be provided at each of the vehicles 411, 412, and 413 of the transport vehicle group 410 and each of the underground transport vehicles 420 (each of the wheels of each of the vehicles). For example, each of the vehicles 411, 412, and 413 of the transport vehicle group 410 may include only an axle without including the drive device 354. For example, only the underground transport vehicle 420 functioning as a traction vehicle may be provided with a drive force. For example, the installation mode of the drive device 354 can be changed according to the design specifications.

### Actions and Effects

In the fourth embodiment, the travel device 350 is provided at each of the vehicles 411, 412, and 413 of the transport vehicle group 410 and each of the underground transport vehicles 420.

According to this configuration, by supporting each of the vehicles 411, 412, and 413 of the transport vehicle group 410 and each of the underground transport vehicles 420 by the travel device 350, each of the vehicles 411, 412, and 413 of the transport vehicle group 410 and each of the underground transport vehicles 420 can stably travel regardless of whether the room has an arcuate road surface or has a flat road surface. In addition, a rail facility for supporting each of the vehicles 411, 412, and 413 of the transport vehicle group 410 and each of the underground transport vehicles 420 is unnecessary.

### Other Embodiments

In the above-described embodiments, an example has been described in which the tunnel boring machine includes the front body to which the cutter head for boring borings is attached, and the rear body connected to the front body via the extension-retraction mechanism, and the travel device is provided at each of the front body and the rear body, but there is no limitation to this. For example, the travel device may be provided at any one of the front body and the rear body. For example, the installation mode of the travel device can be changed according to the design specifications.

In the above-described embodiments, an example has been described in which the travel device is provided at the trailing car following the tunnel boring machine, but the travel device is not limited to this. For example, the travel device need not be provided at the trailing car. For example, the installation mode of the travel device used for the trailing car can be changed according to the design specifications.

In the above-described embodiments, an example has been described in which the travel device includes at least one of the yawing mechanism configured to swing the wheels in the yaw direction on the up-down axis of the travel device, the rolling mechanism configured to swing the wheel in the roll direction on the front-rear axis of the travel device, and the pitching mechanism configured to swing the wheel in the pitch direction on the right-left axis of the travel device, but the travel device is not limited to this. For example, the travel device need not include each of the yawing mechanism, the rolling mechanism, and the pitching mechanism. For example, each of these mechanisms may be mounted on any frame. For example, the installation modes of the yawing mechanism, the rolling mechanism, and the pitching mechanism in the travel device can be changed according to the design specifications.

In the above-described embodiments, an example has been described in which the variable mechanism includes the rod or the cylinder as a part of the mechanism for changing the angle, but the variable mechanism is not limited to this. For example, the variable mechanism need not include the rod or the cylinder as a part of the mechanism for changing the angle. For example, the variable mechanism may include a frame at a part of the mechanism for changing the angle. For example, the installation modes of the rod and the cylinder in the variable mechanism can be changed according to the design specifications.

In the above-described embodiments, an example has been described in which the plurality of trailing cars are provided, the travel device is provided at each of the plurality of trailing cars, and each of the plurality of travel devices includes the drive device for causing the travel device to travel autonomously, but there is no limitation to this. For example, each of the plurality of travel devices need not include the drive device. For example, some of the plurality of travel devices may include a drive device. For example, the installation mode of the drive device in the travel device can be changed according to the design specifications.

In the above-described embodiments, an example has been described in which the tunnel boring system includes the control device that controls each of the plurality of drive devices, but the tunnel boring system is not limited to this. For example, the tunnel boring system need not include the control device described above. For example, the control device may control some of the plurality of drive devices. For example, a mode in which the control device controls the drive device can be changed according to the design specifications.

In the above-described embodiments, an example has been described in which the travel device used for the boring machine and the travel device used for the trailing car have different configurations from each other, but the travel devices are not limited to this. For example, the travel device used for the boring machine and the travel device used for the trailing car may have the same configuration as each other. For example, the travel device used for the boring machine may be provided at the trailing car. For example, the travel device used for the trailing car may be provided at the boring machine. For example, the installation mode of the travel device can be changed according to the design specifications.

In the above-described embodiments, an example has been described in which the transport vehicle group includes a total of seven vehicles from the first vehicle to the seventh vehicle, but the transport vehicle group is not limited to this. For example, the transport vehicle group may include six or less or eight or more vehicles. For example, the number of vehicles constituting a transport vehicle group can be changed according to the design specifications.

In the above-described embodiments, as an example of the tunnel boring system, an example (TBM) including the tunnel boring machine that can move in the front-rear direction by fixing the grippers to the tunnel wall of the tunnel has been described, but the tunnel boring system is not limited to this. For example, the tunnel boring system may include a shield machine that obtains a reaction force from a segment sequentially installed on a tunnel wall of a tunnel and propels itself. For example, a tunnel center position, an inner diameter, and a curvature radius of a curve may be predicted by a sensor not illustrated, and the cylinder (a part of the mechanism for changing the angle) and the yawing cylinder (a part of the yawing mechanism) may be controlled by a controller not illustrated. For example, the configuration mode of the tunnel boring system can be changed according to the design specifications.

Although the embodiments of the present invention have been described above, the present invention is not limited to these, and additions, omissions, substitutions, and other modifications of the configuration are possible without departing from the spirit of the present invention, and the above-described embodiments can also be combined as appropriate.

### (Supplementary Note 1)

A travel device used in a tunnel boring machine, the travel device including:
wheels; and
a variable mechanism configured to change an angle formed by a line orthogonal to a rotation axis of the wheels and a vertical line between a first state in which the travel device travels on a flat road surface and a second state in which the travel device travels on an arcuate road surface in frontal view.

### (Supplementary Note 2)

The travel device according to supplementary note 1, in which the travel device includes at least one of
a yawing mechanism configured to swing the wheels in a yaw direction on an up-down axis of the travel device,
a rolling mechanism configured to swing the wheels in a roll direction on a front-rear axis of the travel device, and
a pitching mechanism configured to swing the wheels in a pitch direction on a right-left axis of the travel device.

### (Supplementary Note 3)

The travel device according to supplementary note 1, in which
the variable mechanism includes a rod in a part of a mechanism for changing the angle.

### (Supplementary Note 4)

The travel device according to supplementary note 3, in which
the variable mechanism changes the angle by switching between rods having different lengths from each other as the rod.

### (Supplementary Note 5)

The travel device according to supplementary note 4, in which the travel device includes
a first link mechanism including the rod as the mechanism for changing the angle, and
a second link mechanism to which one end portion of the first link mechanism is connected, and
the variable mechanism changes a length of the first link mechanism by switching between rods having different lengths from each other as the rod, while a length of the second link mechanism is fixed.

### (Supplementary Note 6)

The travel device according to supplementary note 1, in which
the variable mechanism includes a cylinder in a part of the mechanism for changing the angle.

### (Supplementary Note 7)

The travel device according to supplementary note 6, in which
the variable mechanism changes the angle by changing a length of the cylinder.

### (Supplementary Note 8)

The travel device according to supplementary note 7, in which
the travel device includes a first link mechanism and a second link mechanism as the mechanism for changing the angle, and
the cylinder is provided in the first link mechanism.

### (Supplementary Note 9)

A tunnel boring machine including:
a front body to which a cutter head for boring borings is attached;
a rear body connected to the front body via an extension-retraction mechanism; and
the travel device according to supplementary note 1, in which the travel device is provided at each of the front body and the rear body.

### (Supplementary Note 10)

The tunnel boring machine according to supplementary note 9, in which
the cutter head includes an attachment portion for a travel device.

### (Supplementary Note 11)

A trailing car following the tunnel boring machine, the trailing car including
the travel device according to supplementary note 1.

### (Supplementary Note 12)

A transport vehicle that transports borings, the transport vehicle including
the travel device according to supplementary note 1.

### (Supplementary Note 13)

A tunnel boring system including:
the tunnel boring machine; and
a trailing car following the tunnel boring machine, in which
the travel device according to supplementary note 1 is provided at each of the tunnel boring machine and the trailing car.

### (Supplementary Note 14)

A tunnel boring system including:
the tunnel boring machine;
a trailing car following the tunnel boring machine; and
a transport vehicle configured to transport borings, in which
the travel device according to supplementary note 1 is provided at each of the tunnel boring machine, the trailing car, and the transport vehicle.
   (supplementary Note 15)

A movement method for moving a tunnel boring machine including a front body to which a cutter head for boring borings is attached, a rear body connected to the front body via an extension-retraction mechanism, a front body self-weight support mechanism provided at the front body, a rear body gripper provided at the rear body, and a travel device, the movement method including:
a rear body fixing step of fixing the rear body to a tunnel by the rear body gripper;
a front body self-weight supporting step of grounding the front body self-weight support mechanism and supporting self-weight of the front body after the rear body fixing step;
a forward-moving boring step of moving the front body forward and performing boring by the cutter head after the front body self-weight supporting step;
a rear-body travel device grounding step of releasing the rear body gripper and grounding a travel device provided at the rear body after the forward-moving boring step; and
a rear body forward-moving step of retracting the extension-retraction mechanism and moving the rear body forward together with the travel device after the rear-body travel device grounding step.

### (Supplementary Note 16)

A movement method for moving a tunnel boring machine including a front body to which a cutter head for boring borings is attached, a rear body connected to the front body via an extension-retraction mechanism, and a travel device, in which
after boring of a tunnel by the cutter head is completed, the tunnel boring machine is moved rearward by an allowable distance for the travel device at least between the cutter head and a tunnel wall in front of the cutter head, and after the travel device is attached to the cutter head, the tunnel boring machine is retreated.

### REFERENCE SIGNS LIST

1, 301 Tunnel boring system, 2 Boring transport vehicle, 3 Boring machine, 4 Trailing car group, 5 Cutter head, 6 Traction beam, 7 Control device, 11 First vehicle (Trailing car), 12 Second vehicle (Trailing car), 13 Third vehicle (Trailing car), 14 Fourth vehicle (Trailing car), 15 Fifth vehicle (Trailing car), 16 Sixth vehicle (Trailing car), 17 Seventh vehicle (Trailing car), 20 Underground transport vehicle (Transport vehicle), 31 Front body, 32 Rear body, 33 Extension-retraction mechanism, 35 Vertical support (Front body self-weight support mechanism), 36 Gripper (Rear body gripper), 37 Lower Gripper (Rear body gripper), 49 Attachment portion, 50, 100, 250, 350 Travel device, 51, 101, 251, 351 Wheel, 52, 102, 252, 352A, 352B Variable mechanism, 53 Rod, 55, 105, 255 Yawing mechanism, 57, 257, 357 Rolling mechanism, 70L, 70R, 120L, 120R, 270L, 270R Pitching mechanism, 103, 253 Cylinder, 104 Drive device, 320 Underground transport vehicle (Transport vehicle), 411 First vehicle (Transport vehicle), 412 Second vehicle (Transport vehicle), 413 Third vehicle (Transport vehicle), 420 Underground transport vehicle (Transport vehicle), A Angle

1. A travel device used in a tunnel boring machine, the travel device comprising:
wheels; and
a variable mechanism configured to change an angle formed by a line orthogonal to a rotation axis of the wheels and a vertical line between a first state in which the travel device travels on a flat road surface and a second state in which the travel device travels on an arcuate road surface in frontal view.

2. The travel device according to claim 1, wherein
the travel device comprises at least one of
a yawing mechanism configured to swing the wheels in a yaw direction on an up-down axis of the travel device,
a rolling mechanism configured to swing the wheels in a roll direction on a front-rear axis of the travel device, and
a pitching mechanism configured to swing the wheels in a pitch direction on a right-left axis of the travel device.

3. The travel device according to claim 1, wherein
the variable mechanism includes a rod in a part of a mechanism for changing the angle.

4. The travel device according to claim 3, wherein
the variable mechanism changes the angle by switching between rods having different lengths from each other as the rod.

5. The travel device according to claim 4, wherein
the travel device comprises
a first link mechanism including the rod as the mechanism for changing the angle, and
a second link mechanism to which one end portion of the first link mechanism is connected, and
the variable mechanism changes a length of the first link mechanism by switching between rods having different lengths from each other as the rod, while a length of the second link mechanism is fixed.

6. The travel device according to claim 1, wherein
the variable mechanism includes a cylinder in a part of the mechanism for changing the angle.

7. The travel device according to claim 6, wherein
the variable mechanism changes the angle by changing a length of the cylinder.

8. The travel device according to claim 7, wherein
the travel device comprises a first link mechanism and a second link mechanism as the mechanism for changing the angle, and
the cylinder is provided in the first link mechanism.

9. A tunnel boring machine comprising:
a front body to which a cutter head for boring borings is attached;
a rear body connected to the front body via an extension-retraction mechanism; and
the travel device according to claim 1, wherein
the travel device is provided at each of the front body and the rear body.

10. The tunnel boring machine according to claim 9, wherein
the cutter head includes an attachment portion for a travel device.

11. A trailing car following the tunnel boring machine, the trailing car comprising
the travel device according to claim 1.

12. A transport vehicle that transports borings, the transport vehicle comprising
the travel device according to claim 1.

13. A tunnel boring system comprising:
the tunnel boring machine; and
a trailing car following the tunnel boring machine, wherein
the travel device according to claim 1 is provided at each of the tunnel boring machine and the trailing car.

14. A tunnel boring system comprising:
the tunnel boring machine;
a trailing car following the tunnel boring machine; and
a transport vehicle configured to transport borings, wherein
the travel device according to claim 1 is provided at each of the tunnel boring machine, the trailing car, and the transport vehicle.

15. A movement method for moving a tunnel boring machine including a front body to which a cutter head for boring borings is attached, a rear body connected to the front body via an extension-retraction mechanism, a front body self-weight support mechanism provided at the front body, a rear body gripper provided at the rear body, and a travel device, the movement method comprising:
a rear body fixing step of fixing the rear body to a tunnel by the rear body gripper;
a front body self-weight supporting step of grounding the front body self-weight support mechanism and supporting self-weight of the front body after the rear body fixing step;
a forward-moving boring step of moving the front body forward and performing boring by the cutter head after the front body self-weight supporting step;
a rear-body travel device grounding step of releasing the rear body gripper and grounding a travel device provided at the rear body after the forward-moving boring step; and
a rear body forward-moving step of retracting the extension-retraction mechanism and moving the rear body forward together with the travel device after the rear-body travel device grounding step.

16. A movement method for moving a tunnel boring machine including a front body to which a cutter head for boring borings is attached, a rear body connected to the front body via an extension-retraction mechanism, and a travel device, wherein
after boring of a tunnel by the cutter head is completed, the tunnel boring machine is moved rearward by an allowable distance for the travel device at least between the cutter head and a tunnel wall in front of the cutter head, and after the travel device is attached to the cutter head, the tunnel boring machine is retreated.
